(19) United States
(12) Patent Application Publication
(10) Pub. No.: US 2008/0288566 A1
(43) Pub. Date: Nov. 20, 2008

(54) MULTIMEDIA INFORMATION PROVIDING SYSTEM, SERVER DEVICE, TERMINAL EQUIPMENT, MULTIMEDIA INFORMATION PROVIDING METHOD, AND COMPUTER-READABLE MEDIUM

(75) Inventors: Ken UMENO, Saitama (JP); Gen HORI, Saitama (JP); Andrzej CICHOCKI, Saitama (JP); Rafal ZDUNEK, Saitama (JP); Shun-ichi AMARI, Saitama (JP)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(73) Assignees: RIKEN, Saitama (JP); CHAOS WARE, INC., Tokyo (JP)

(21) Appl. No.: 12/054,106

(22) Filed: Mar. 24, 2008

(30) Foreign Application Priority Data
Mar. 23, 2007 (JP) JP 2007-077573

(51) Int. Cl. G06F 7/58

(52) U.S. Cl. 708/250

(57) ABSTRACT

In a multimedia information providing system, responding to a preview request from a terminal equipment, a server device generates a chaotic random number sequence from an initial value allocated to the terminal equipment, mixes this sequence into a set of multimedia information as a noise signal at a first mixing ratio, and then transmits the result as a first set of multimedia information for distribution. Responding to a quality improvement request, the server device generates a chaotic number sequence from the initial value allocated to the terminal equipment, mixes this sequence into a set of multimedia information as a noise signal at a second mixing ratio, and then transmits the result as a second set of multimedia information for distribution. The terminal equipment performs component analysis on the first and second sets of multimedia information, removing the noise and restoring a high-quality version.

### RELATED APPLICATION

This application claims priority to Japanese Patent Application Serial No. 2007-077573 filed Mar. 23, 2007.

### BACKGROUND OF THE INVENTION

1. Field of the Invention

The present invention relates to a multimedia information providing system, server device, terminal equipment, multimedia information providing method, as well as a computer-readable medium recording a program that realizes the same on a computer or digital signal processor, wherein when a user who has previewed a low-quality set of multimedia information requests a high-quality version of the multimedia information, the high-quality version of the multimedia information is acquired by providing another previewable, low-quality set of the multimedia information, thereby eliminating the need for the user to manage encryption keys or similar information.

2. Description of the Related Art

Conventionally, a technique has been used wherein when providing multimedia information such as audio, still images, or moving images to users for preview, low-quality versions having a low bit rate or sampling rate are used, while high-quality multimedia information is provided separately to users wishing to purchase the information. At the same time, in the case where a mixed signal made up of signals from a plurality of signal sources having different mixing ratios is acquired, independent component analysis is widely used as a technique to separate the signal and restore the original signal sources.

Technologies related to these techniques are disclosed, for example, in the following literature.

### Patent Literature 1: Japanese Patent No. 3214837

### Patent Literature 2: Unexamined Japanese Patent Application KOKAI Publication No. 2003-141102

Non-patent Literature 1: A. Cichocki, S. Amari, R. Zdunek, R. Kompass, G. Hori and Z. He, “Extended SMART Algorithms for Non-Negative Matrix Factorization,” Lecture Notes in Artificial Intelligence, Vol. 4029 (2006), pp. 548-562, (8th International Conference on Artificial Intelligence and Soft Computing, ICAISC06, Zakopane, Poland, 25-29, Jun. 2006), June 2006

In the patent literature 1 herein, technology is proposed wherein a random number sequence derived from a chaotic sequence is used as a digital watermark for a set of multimedia information, and it is determined whether or not a digital watermark is attached to the multimedia information by passing the seed for this chaotic sequence. In other words, while a low-quality version of the multimedia information is made by making use of a digital watermark, the digital watermark can be removed from the multimedia information using the seed for the chaotic sequence as a key, thus restoring the set of multimedia information to a high-quality version.

Meanwhile, the patent literature 2 proposes technology wherein principal component analysis or independent component analysis is used to separate a change in the quantity of a chemical substance into a plurality of components, and then the causes for the formation of the chemical substance are grouped using these components.

Typically, independent component analysis involves the following:

(1) Upon receiving an observed signal from a number of channels m, the observed values are arranged in rows in the time direction and an observed signal matrix X is formed, consisting of m rows (arranged in the order of the channels) and T columns.

The observed signal matrix X is then separated into:

(2) a source signal matrix S consisting of n rows and T columns, wherein the source signal values of the source signal from a number of channels n are arranged in rows in the time direction, and the n rows are arranged in the order of the channels;

(3) a mixing ratio matrix A consisting of m rows and n columns and showing the path from the respective channels of the source signal to the respective channels of the observed signal; and

(4) a noise matrix N consisting of m rows and T columns.

At this point, separation is performed such that for a given matrix operation c(x,y), the condition

(5) X=c(A,S)+N

is satisfied. Matrix multiplication, matrix convolutions, and various non-linear matrix link functions may be used as the matrix operation c(x,y).

In addition, while at this point it is typical to use iterative methods such as the gradient method, the conjugate gradient method, or Newton's method, the following is adopted as a cost function:

(6) a matrix function J(x,y,z) that takes a matrix of m rows and T columns, a matrix of m rows and n columns, and a matrix of n rows and T columns, and returns a scalar value.

More specifically, for a J(X,A,S) wherein X is fixed and A,S are varied, a combination of A and S are computed such that the value of J(X,A,S) is minimized (i.e., a minimum. Typically, the function solves for a maximum or a minimum, or in other words, an extremum.)

Examples of functions that can be used as this cost function include: a function J(X,A,S) that returns the absolute value of the element with the largest absolute value in the matrix X−AS (i.e., the maximum absolute value of the elements); a function that returns the average of the squares of each element in the matrix X−AS; and a function that returns the total sum of the squares of each element in the matrix X−AS. In addition, other constraints, such as non-negativity, sparseness, and statistical independence may be applied as necessary.

If only iterative methods are applied, there is a problem in that convergence takes a significant amount of time and signal separability decreases in the case where there are large differences in signal strengths among the source signals, or in the case where the differences among the observed signals are slight (i.e., the case wherein the observed signals are similar).

Consequently, the inventors are pursuing research signal separation technology so as to improve signal separability and reach convergence quickly, as is disclosed in the non-patent literature 1. Moreover, the inventors are searching for fields wherein this technology can be applied.

### SUMMARY OF THE INVENTION

However, in the invention disclosed in the patent literature 1, it is necessary to pass a seed for a chaotic number sequence, which acts as an encryption key, to the recipient of the multimedia information. However, when such encryption key information is managed on the provider's side, and not on the user's side, the possibility of unauthorized use can be more often suppressed to a low level.

In addition, there is great demand to make it difficult to eavesdrop or snoop the information exchanged between the user and the provider by applying the various signal separation technologies disclosed in the patent literature 2 and the non-patent literature 1.

It is an object of the present invention, being devised in order to solve problems such as the foregoing, to provide a multimedia information providing system, server device, terminal equipment, multimedia information providing method, as well as computer-readable medium recording a program that executes the same on a computer or digital signal processor, wherein when a user who has previewed a low-quality set of multimedia information requests a high-quality version of the multimedia information, the high-quality version of the multimedia information is acquired by providing another previewable, low-quality set of the multimedia information, thus eliminating the need for the user to manage encryption keys or similar information.

The multimedia information providing system in accordance with a first aspect of the present invention includes a server device and a terminal equipment, and has the following configuration.

Specifically, the server device is provided with: a multimedia information storage component, wherein multimedia information including at least one of audio or images is stored in advance; a chaotic sequence generator that generates a random number sequence derived from a chaotic sequence, taking a value provided as input as an initial value; an initial value selector that selects an initial value; a first random number sequence acquirer that acquires a random number sequence generated by providing a selected initial value as input into the chaotic sequence generator; a first mixer that mixes the random number acquired by the first random number sequence acquirer into stored multimedia information as a noise signal at a first mixing ratio, thereby acquiring a first set of multimedia information for distribution; a first transmitter that transmits the acquired first set of multimedia information for distribution to a terminal equipment; and an initial value storage component that associates and stores a selected initial value with a corresponding terminal equipment.

The terminal equipment is provided with: a first receiver that receives the first set of multimedia information for distribution that was transmitted from the server device; a first reproducer that reproduces the received first set of multimedia information for distribution; and a request transmitter that transmits to the server device a quality improvement request that requests a second set of multimedia information, being a higher-quality version of the first set of multimedia information that was reproduced.

The server device is furthermore provided with: a request receiver that receives an improvement request transmitted from the terminal equipment; a second random number sequence acquirer that takes the initial value that was stored in the initial value storage component in association with the terminal equipment that transmitted the received quality improvement request, provides this initial value as input into the chaotic sequence generator, and then acquires the random number sequence generated thereby; a second mixer that mixes the random number acquired by the second random number sequence acquirer into stored multimedia information as a noise signal at a second mixing ratio that is different from the corresponding first mixing ratio, thereby acquiring a second set of multimedia information for distribution; and a second transmitter that transmits the acquired second set of multimedia information for distribution to the terminal equipment.

The terminal equipment is furthermore provided with: a second receiver that receives the second set of multimedia information for distribution that was transmitted from the server device; a component analyzer that takes the received first set of multimedia information for distribution and the received second set of multimedia information for distribution as input signals and performs component analysis, thereby obtaining two component signals; a information selector that selects, from among the two output component signals, the component signal that exhibits the lower degree of chaotic sequence characteristics, and selects this component signal as the high-quality multimedia information; and a high-quality reproducer that reproduces the selected high-quality multimedia information.

In addition, the multimedia information providing system of the present invention may be configured such that the degree to which a given component signal exhibits chaotic sequence characteristics is determined by a return map, the correlation dimension, or the maximal Lyapunov exponent of the component signal.

In addition, the multimedia information providing system of the present invention may be configured such that the chaotic sequence is obtained by iteratively applying a function F(x) having a domain and range of values given by a predefined region D to an arbitrary initial value z included in D, thus yielding a sequence of the form

z, F(z), F(F(z)), F(F(F(z))), . . .

For a given component signal

s₁, s₂, s₃, . . .

the characteristic value expressing the degree to which the component signal exhibits characteristics of the chaotic sequence is determined by taking the total sum, the sum of squares, the average, or the weighted average of the error

|sᵢ₊₁−F(sᵢ)|

of the i+1 (i≧1) element in the component signal. The degree to which the component signal exhibits the characteristics of the chaotic sequence is high to the extent that this characteristic value is small.

In addition, the multimedia information providing system of the present invention may also be configured such that the function F(x) is the Chebyshev polynomial Tₐ(x) of degree a (a≧2), defined as

Tₐ(cos θ)=cos(aθ)

In addition, the multimedia information providing system of the present invention may also be configured such that the terminal equipment is furthermore provided with a second reproducer that reproduces the received second set of multimedia information for distribution.

In addition, the multimedia information providing system of the present invention may also be configured such that the initial value selector in the server device randomly selects an initial value for each terminal equipment.

A server device in accordance with another aspect of the present invention is the server device included in the above multimedia information providing system.

A terminal equipment in accordance with another aspect of the present invention is the terminal equipment included in the above multimedia information providing system.

A multimedia information providing method in accordance with another aspect of the present invention makes use of a server device and a terminal equipment. The server device includes: a multimedia information storage component wherein multimedia information, including at least one of audio or images, is stored in advance; a chaotic sequence generator, an initial value selector, a first random number sequence acquirer, a first mixer; and first transmitter; an initial value storage component; a request receiver; a second random number sequence acquirer; a second mixer; and a second transmitter. The terminal equipment includes: a first receiver; a first reproducer; a request transmitter; a second receiver; a component analyzer; a information selector; and a high-quality reproducer. The method has the following configuration.

More specifically, on the server device the method comprises: a chaotic sequence generation step, wherein the chaotic sequence generator generates a random number sequence derived from a chaotic sequence, taking a value provided as input as an initial value; an initial value selection step, wherein the initial value selector selects an initial value; a first random number sequence acquisition step, wherein the first random number sequence acquirer provides a selected initial value as input into the chaotic sequence generation step, and acquiring the random number sequence generated thereby; a first mixing step, wherein the first mixer mixes the random number acquired in the first random number sequence acquisition step into stored multimedia information as a noise signal at a first mixing ratio, thereby obtaining a first set of multimedia information for distribution; a first transmission step, wherein the first transmitter transmits the obtained first set of multimedia information for distribution to the terminal equipment; and an initial value storage step, wherein the initial value storage component associates and stores a selected initial value with a corresponding terminal equipment.

Meanwhile, on the terminal equipment the method comprises: a first receiving step, wherein the first receiver receives the first set of multimedia information for distribution that was transmitted from the server device; a first reproduction step, wherein the first reproducer reproduces the received first set of multimedia information for distribution; and a request transmission step, wherein the request transmitter transmits to the server device a quality improvement request that requests a second set of multimedia information, being a higher-quality version of the first set of multimedia information for distribution that was reproduced.

Furthermore, on the server device the method comprises: a request receiving step, wherein the request receiver receives the quality improvement request transmitted from the terminal equipment; a second random number sequence acquisition step, wherein the second random number sequence acquirer takes the initial value stored in the initial value storage step that is associated with the terminal equipment that transmitted the received quality improvement request, provides this initial value as input into the chaotic sequence generation step, and then acquires the random number sequence generated thereby; a second mixing step, wherein the second mixer mixes the random number acquired in the second random number sequence acquisition step into stored multimedia information as a noise signal at a second mixing ratio that is different from the first mixing ratio, thereby obtaining a second set of multimedia information for distribution; and a second transmission step, wherein the second transmitter transmits the obtained second set of multimedia information for distribution to the terminal equipment.

Furthermore, on the terminal equipment the method furthermore comprises: a second receiving step, wherein the second receiver receives the second set of multimedia information for distribution transmitted from the server device; a component analysis step, wherein the component analyzer takes the received first set of multimedia information for distribution and the received second set of multimedia information for distribution as input signals and performs component analysis, thereby obtaining two component signals; a information selection step, wherein the information selector selects, from among the two output component signals, the component signal that exhibits the lower degree of chaotic sequence characteristics, and selects this component signal as the high-quality multimedia information; and a high-quality reproduction step, wherein the high-quality reproducer reproduces the selected high-quality multimedia information.

In addition, the multimedia information providing method of the present invention may be configured such that the degree to which a given component signal exhibits chaotic sequence characteristics is determined by a return map, the correlation dimension, or the maximal Lyapunov exponent of the component signal.

In addition, the multimedia information providing method of the present invention may be configured such that the chaotic sequence is obtained by iteratively applying a function F(x) having a domain and range of values given by a set region D to an arbitrary initial value z included in D, thus yielding a sequence of the form

z, F(z), F(F(z)), F(F(F(z))), . . .

For a given component signal

s₁, s₂, s₃, . . .

the characteristic value expressing the degree to which the component signal exhibits characteristics of the chaotic sequence is determined by taking the total sum, the sum of squares, the average, or the weighted average of the error

|sᵢ₊₁−F(sᵢ)|

of the i+1(i≧1) element in the component signal. The degree to which the component signal exhibits the characteristics of the chaotic sequence is high to the extent that this characteristic value is small.

In addition, the multimedia information providing method of the present invention may also be configured such that the function F(x) is the Chebyshev polynomial Tₐ(x) of degree a (a≧2), defined as

Tₐ(cos θ)=cos(aθ)

In addition, the multimedia information providing method of the present invention may also be configured such that the terminal equipment is furthermore provided with a second reproducer, and the method furthermore includes a second reproduction step, wherein the second reproducer reproduces the received second set of multimedia information for distribution.

In addition, the multimedia information providing method of the present invention may also be configured such that on the server device, in the initial value selection step, an initial value is randomly selected for each terminal equipment.

A computer-readable medium recording a program in accordance with another aspect of the present invention is configured so as to cause a computer or digital signal processor to function as the respective components of the server device or the respective components of the terminal equipment of the foregoing multimedia information providing system, or alternatively, to execute the foregoing multimedia information providing method.

In addition, the computer-readable medium recording a program of the present invention may also be recorded onto a computer-readable information storage medium, such as a compact disc, a flexible disk, a hard disk, a magneto-optical disk, a digital video disk, magnetic tape, semiconductor memory, or similar means.

The above computer-readable medium recording a program may also exist independently of the computer or digital signal processor that executes the program, and be distributed or sold via a computer communications network. Moreover, the above information storage media may also be distributed or sold independently of the computer or digital signal processor.

As a result of the present invention, a multimedia information providing system, server device, terminal equipment, multimedia information providing method, as well as a computer-readable medium recording a program that executes the same on a computer or digital signal processor can be provided, wherein when a user who has previewed a low-quality set of multimedia information requests a high-quality version of the multimedia information, the high-quality version of the multimedia information is acquired by providing another previewable, low-quality set of the multimedia information, thus eliminating the need for the user to manage encryption keys or similar information.

Hereinafter, embodiments of the invention will be described. It should be appreciated that the embodiments to be hereinafter described are given for the sake of explanation, and are not intended to limit the scope of the invention. Consequently, while those skilled in the art may be able to adopt embodiments wherein all or part of these elements have been replaced with their respective equivalents, such embodiments are also to be included within the scope of the present invention.

Furthermore, in the following description, independent component analysis is given as an example of the component analysis technique. However, by using a technique similar to the above, the component analysis technique may be replaced with principal component analysis (including component analysis by sphereing) non-negative matrix factorization, and such embodiments are also to be included within the scope of the present invention.

In addition, in the following description, the matrix operation c(x,y) is given as an example of the matrix product in order to ease understanding. However, matrix convolutions and various non-linear matrix link functions may also be used, and cases wherein such functions are adopted are also to be included within the scope of the present invention.

### BRIEF DESCRIPTION OF THE DRAWINGS

These objects and other objects and advantages of the present invention will become more apparent upon reading of the following detailed description and the accompanying drawings in which:

FIG. 1 is a schematic diagram illustrating the schematic configuration of an iterative estimator for conducting the independent component analysis utilized in an embodiment of the invention.

FIG. 2 is a schematic diagram illustrating the configuration of a signal separation device for conducting the independent component analysis utilized in an embodiment of the invention.

FIG. 3 is a flowchart illustrating the control flow of the signal separation processing executed in the signal separation device.

FIG. 4 is a graph showing the nature of the waveforms of the source signal in Test 1.

FIG. 5 is a graph showing the nature of the waveforms of the observed signal in Test 1.

FIG. 6 is a graph of the waveforms in Test 1, in the case where independent component analysis is conducted on the four signals via the technique of the present embodiment, using the conjugate gradient method with L=10.

FIG. 7 is a graph of the waveforms in Test 1, in the case where independent component analysis is conducted on the four signals via the conventional technique.

FIG. 8 is a graph showing the nature of the waveforms of the source signal in Test 2.

FIG. 9 is a graph showing the nature of the waveforms of the observed signal in Test 2.

FIG. 10 is a graph of the waveforms obtained in Test 2 via the technique of the present embodiment, wherein the iterative estimators use Amari's a-divergence NMF algorithm with L=5.

FIG. 11 is a graph showing the SIR (signal to interference ratio) values in Test 2.

FIG. 12 shows a graph of the waveforms obtained in Test 2 using the conventional technique of the NMF Lee-Seung algorithm.

FIG. 13 is a diagram showing the images which act as the source signal in Test 3.

FIG. 14 is a diagram showing the images corresponding to the observed signal in Test 3.

FIG. 15 is a diagram showing the nature of the source signal obtained in Test 3, in the case where the technique of the present embodiment is adopted with L=5.

FIG. 16 is a diagram showing the nature of the source signal obtained in Test 3, in the case wherein the technique of the present embodiment is adopted with L=2.

FIG. 17 is a diagram showing the source signal images obtained in Test 3 using the conventional technique of the NMF Lee-Seung algorithm.

FIG. 18 is a graph showing the SIR values of the signal from the technique of the present embodiment in Test 3.

FIG. 19 is an explanatory diagram illustrating the schematic configuration of the multimedia information providing system in accordance with the present embodiment.

FIG. 20 is a graph illustrating the nature of Chebyshev polynomials.

FIG. 21 is a graph illustrating the distribution up to a certain point of a chaotic random number generated using a Chebyshev polynomial provided with a suitable initial value suitable.

FIG. 22 is a session diagram illustrating the nature of communication between the server device and the terminal equipment of the multimedia information providing system.

FIG. 23 is an explanatory diagram illustrating the schematic configuration of the server device of the multimedia information providing system.

FIG. 24 is an explanatory diagram illustrating the schematic configuration of the terminal equipment of the multimedia information providing system.

FIG. 25 is a flowchart showing the control flow of the service processing executed on the server device of the multimedia information providing system.

FIG. 26 is a flowchart showing the control flow of the terminal processing executed on the terminal equipment of the multimedia information providing system.

FIG. 27 is an explanatory diagram illustrating the nature of the waveform of an original multimedia signal.

FIG. 28 is an explanatory diagram illustrating the waveforms of two sets of multimedia information for distribution with an initial value of 0.2.

FIG. 29 is an explanatory diagram illustrating the waveforms of the two component signals obtained as a result of applying independent component analysis to two sets of multimedia information for distribution with an initial value of 0.2.

FIG. 30 is an explanatory diagram illustrating the waveforms of two sets of multimedia information for distribution with an initial value of 0.4.

FIG. 31 is an explanatory diagram illustrating the waveforms of the two component signals obtained as a result of applying independent component analysis to two sets of multimedia information for distribution with an initial value of 0.4.

FIG. 32 is an explanatory diagram illustrating the waveforms of two sets of multimedia information for distribution having different initial values.

FIG. 33 is an explanatory diagram illustrating the waveforms of the two component signals obtained as a result of applying independent component analysis to two sets of multimedia information for distribution having different initial values.

### DETAILED DESCRIPTION OF THE PREFERRED EMBODIMENTS

Hereinafter, the following will be described in order to ease understanding:

(1) First, independent component analysis as applicable to the present invention will be described;
(2) Subsequently, the multimedia information providing system in accordance with an embodiment of the present invention will be described in detail.

Independent Component Analysis

In order to ease understanding of the computational processes involved in the present embodiment, the various symbols used herein will be now be described. In the present embodiment, the following matrix X is used as the input for signal separation.

(1) Observed signal matrix X, having m rows and T columns

In addition, the following matrices A, S, and N are obtained as the results of the signal separation.

(2) Mixing ratio matrix A, having m rows and n columns

(3) Source signal matrix S, having n rows and T columns

(4) Noise matrix N, having m rows and T columns

However, these matrices must exist in the following relationship:

(5) X=AS+N.

Moreover, when X is fixed and A and S are infinitesimally varied, the cost function J(X,A,S) must yield an absolute or a local minimum. (Depending on the type of the cost function, the result may be an extremum, including absolute or local maxima. Hereinafter, the cost function will be taken to solve for a minimum, in order to ease understanding). In other words, the following must hold true:

(6) (A,S)=arg min_{(A,S)}J(X,A,S).

In typical independent component analysis techniques, the following may be used as the above cost function: a function that returns the absolute value of the element with the largest absolute value in the matrix X−AS (i.e., the maximum absolute value of the elements), a function that returns the average of the squares of each element in the matrix X−AS, or a function that returns the total sum of the squares of each element in the matrix X−AS. In addition, other functions, such as Amari's a-divergence, Kullback-Leibler divergence, the Frobenius norm, and Jenssen-Shannon divergence may also be used.

In addition, an iterative method (such as the gradient method, the conjugate gradient method, or Newton's method) is adopted as the computational technique to solve for the above matrices A and S. Ordinarily, this method is iterated until A and S meet a predefined completion condition. For example, the completion condition to be satisfied may be such that the ratio of the total sum of the squares of the differences in the elements before and after iteration of A and S with respect to the total sum of the squares of the elements in the matrices becomes less than a set value ε.

Naturally, in cases where rough analysis is sufficient, the number of iterations may also be fixed to a certain number. This latter case is equivalent to specifying “iteration number xx” as the completion condition.

Computation may also be conducted by applying constraints based on already known properties of the signal to be separated. These constraints may include non-negativity, sparseness, space-time decorrelation, smoothness, and independence.

In the present embodiment, a single computational module referred to as the iterative estimator is taken to perform the functions of conducting independent component analysis like the above. A variety of independent component analysis techniques as well as existing techniques can be applied to the processes executed by the iterative estimator.

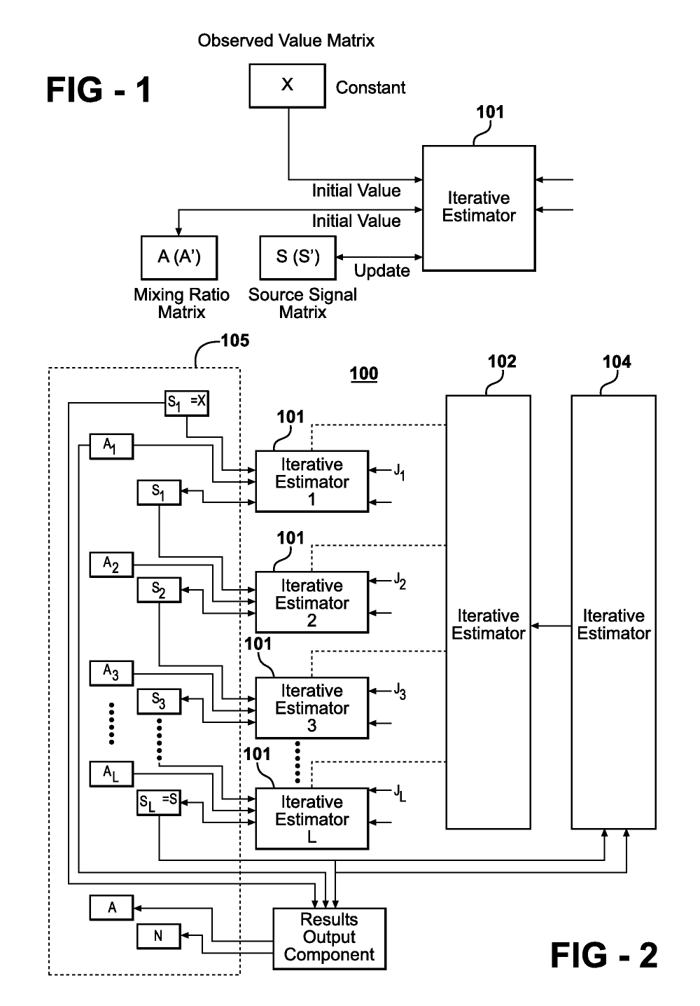

FIG. 1 is an explanatory diagram illustrating input and output with respect to the iterative estimator. The description hereinafter will refer to this diagram.

An iterative estimator 101 is realized by the joint operation of a typical computer CPU (central processing unit) and a storage device such as RAM (random access memory).

The matrices X, A, and S are provided to the iterative estimator 101 as input. Typically, the matrices X, A, and S are stored in the RAM or similar memory. The present embodiment is configured such that the addresses of the matrices X, A, and S stored in memory are passed as arguments to the library (program) functions that realize the iterative estimator 101.

Although the matrix X herein is equivalent to observed signal matrix as described above, in a broader sense the matrix X can be thought of as a constant matrix that defines the parameters involved in the iterative method. Likewise, although the matrices A and S provided herein are the mixing ratio matrix and the source signal matrix, in a broader sense these can be thought of as the initial values that approximate the true values in the iterative method. Consequently, it is necessary for the matrices A and S stored in the RAM or similar memory to be initialized with some set of values.

In the case where there is no information whatsoever, various techniques are possible (given in the diagram as “Initialization”), such as assigning a random number or a constant (such as 0, 1, or −1) to each element in the matrix A such that the element distribution becomes sparse, and assigning a random number or a constant (such as 0, 1, or −1) to each element in the matrix S. In addition, as described in a later section, the iterative estimator 101 may also take the output results from the previous process as the initial values, this being preferable in many cases.

In addition to the above, the cost function and the completion condition are also provided to the iterative estimator 101. These may be specified directly in the code (program) used to realize the iterative estimator 101, or provided by specifying the address of a library function.

The iterative estimator 101 receives the various information described above, iterates until the completion condition is satisfied, and then outputs the matrices A′ and S′, the values thereof being closer to the true values than the matrices A and S provided as input. The matrices A′ and S′ being output is equivalent to the completion condition being met. Herein, the following are given as examples of the completion condition.

(1) The number of iterations has become 1.
(2) The number of iterations has become a set number n (n≧2)
(3) (Σᵢ₌₁^{m}Σₖ₌₁ⁿ|A′[i,k]−A[i,k]|²+Σₖ₌₁ⁿΣₜ₌₁^{T}|S′[i,k]−S[i,k]|²)≦ε
(4) (maxᵢ₌₁^{m}maxₖ₌₁ⁿ|A′[i,k]−A[i,k]|²+maxₖ₌₁ⁿmaxₜ₌₁^{T}|S′[i,k]−S[i,k]|²)≦ε
(5) Σᵢ₌₁^{m}Σₖ₌₁ⁿ|A′[i,k]−A[i,k]|²≦ε
(6) max₌₁^{m}maxₜ₌₁^{T}|A′[i,k]−A[i,k]|²≦ε
(7) Σₖ₌₁ⁿmaxₜ₌₁^{T}|S′[i,k]−S[i,k]|²≦ε
(8) maxₖ₌₁ⁿmaxₜ₌₁^{T}|S[i,k]−S[i,k]|²≦ε

It is preferable that output results and the output method involve overwriting the region in the RAM or similar memory where the matrices A and S that were provided as input are stored, the region being overwritten with the information of A′ and S′ (given in the diagram as “Overwrite”). The present embodiment primarily adopts such a configuration.

Stated in conjunction with the above points: in the iterative method, X is fixed while A and S are moved in the direction such that J(X,A,S) becomes smaller, thereby yielding the results A′ and S′, and thus it can be difficult to apply the gradient method or similar method to both matrices A and S.

Consequently, the cost function J(X,A,S) is treated as a combination of two cost functions K(X,A,S) and H(X,A,S). Herein, K(x,y,z) and H(x,y,z) may be selected to be identical cost functions (i.e., the three cost functions K, H, and J are the same), or suitably different cost functions may be selected.

A single iteration of the iteration method is thus typically:

(1) First, X and A are fixed while S is moved in the direction such that K(X,A,S) becomes smaller, the results thereof taken to be S′; and

(2) Next, X and S′ are fixed while A is moved in the direction such that H(X,A,S′) becomes smaller, the results thereof taken to be A′.

Alternatively, a single iteration of the iteration method may also involve the reverse:

(1) First, X and S are fixed while A is moved in the direction such that H (X,A,S) becomes smaller, the results thereof taken to be A′; and

(2) Next, X and A′ are fixed while S is moved in the direction such that K(X,A′,S) becomes smaller, the results thereof taken to be S′.

In the present embodiment, the iterative estimator 101 as described above is used at least a number of times L (L≧2) via a subroutine call, but the provided arguments and other parameters in this case may differ. Thus, in order to ease understanding, the description hereinafter will assume that a number L of iterative estimators 101 have been individually prepared.

FIG. 2 is a schematic diagram illustrating the configuration of a signal separation device in accordance with the present embodiment. The description hereinafter will refer to this diagram.

A signal separation device 100 is provided with a number L of iterative estimators 101, a iterative counter 102, a results output component 103, a iteration controller 104, as well as a storage component 105.

In the present embodiment, since independent component analysis is performed by way of a multi-step iterative estimator, L is equivalent to the “step number” or “layer number”.

In the storage component 105, regions for storing the following information are reserved.

(1) An observed signal matrix X, having m rows and T columns. This is the set of observed values that act as the target for signal separation.

(2) A number L of matrices A₁ . . . A_{L}. These are used for intermediate calculations.

(3) A number L of matrices S₁ . . . S_{L}, having n rows and T columns. These are used for intermediate calculations.

(4) A mixing ratio matrix A, having m rows and n columns. This is one of the results of signal separation.

(5) A noise matrix N, having m rows and T columns. This is one of the results of signal separation.

It should be appreciated that the source signal matrix S, having n rows and T columns and being one of the results of signal separation, can also be identified as S_{L}.

In addition, in order to ease understanding of the expression of recurrence equations, the matrix X will be hypothetically identified as S₀.

Furthermore, hereinafter matrix names and the regions within the storage component 105 where the values of elements in the matrices are stored will be represented using the same symbols, as long as doing so does not create confusion.

The number L of matrices A₁ . . . A_{L} are defined such that the set computation c(x,y)

c(A₁, c(A₂, c(A₃, c( . . . , c(A_{L-1}, A_{L}) . . . ))))

yields a matrix of m rows and n columns. In the present embodiment, the matrix product is used as c(x,y).

Consequently, in the present embodiment, the constant determining the row numbers and the column numbers of the number L of matrices is determined uniquely as

n₀=m, n₁, n₂, . . . , n_{L-1}, n_{L}=n

and thus Aᵢ is a matrix having nᵢ₋₁ rows and nᵢ columns.

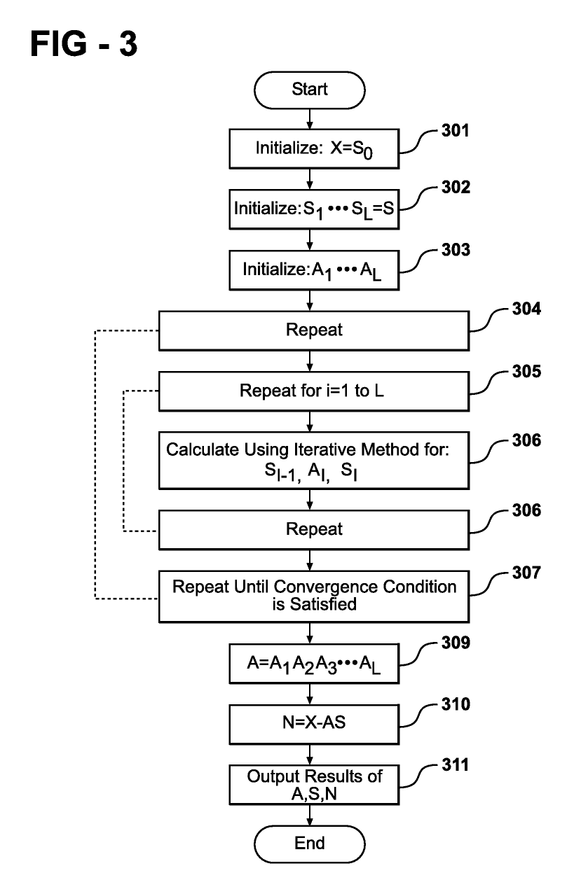

FIG. 3 is a flowchart illustrating the control flow of the signal separation processes executed in the signal separation device. The description hereinafter will refer to this diagram.

When processing commences in the signal separation device 100, the values of the observed signal that acts as the input are set in the matrix X (i.e., the matrix S₀) (step S301).

Next, the matrices S₁, S₂ . . . , S_{L-1}, S_{L} are initialized with suitable values (step S302). Herein, the matrix S_{L} can be identified as the matrix S.

Furthermore, the matrices A₁, A₂, . . . , A_{L-1}, A_{L} are initialized with suitable values (step S303).

Various techniques in addition to initialization using the foregoing initial values may also be applied to the initialization of values in step S302 and step S303. In the present embodiment, these initialization processes are realized by the joint operation of the CPU and the RAM or similar memory.

Next, the iteration controller 104 repeats the following processes of step S304 to step S308 (step S304) for as long as the convergence condition is not satisfied (step S308). A variety of conditions similar to the completion condition may be adopted as the convergence condition. Typically the convergence condition is considered to be satisfied when the variations of the matrix S₁ . . . S_{L} and the matrix A₁ . . . A_{L} have become exceedingly small in the current iteration.

Naturally, depending on the field of application, the convergence condition by which the terminus of the repetition is determined may also be set to always be true. In this case, the repetition is conducted only once, and in practice this simply reduces to serial processing.

Thus, the iteration controller 104 is realized by the CPU working in conjunction with the RAM or similar memory.

During these repetitions, the processing of the following steps S305 to S307 are repeated. At the same time, the iterative counter 102 increases a counter variable i by 1 per repetition from an initial value of 1 until a final value L is reached.

Thus, the iterative counter 102 is realized by the CPU working in conjunction with the RAM or similar memory.

More specifically, the ith iterative estimator 101 is provided the matrices Sᵢ₋₁, Aᵢ, and Sᵢ as input, and causes the computational processing of the foregoing iterative method to be conducted (step S306).

As described in the foregoing, the computational processing of the iterative method in step S306 is iterated until a completion condition is satisfied, but the selection of the completion condition may be varied to suit the field of application or one's goals.

In addition, the cost function Jᵢ and the completion condition (i) provided for the ith iterative estimator 101 may be identical for all values of i=1 . . . L, or they may be different.

The matrices Aᵢ and Sᵢ are the matrices whose values have become closer to the “actual values” via the iterative method in the processing in step S306. Moreover, as described above, the estimated results of the iterative estimator 101 for this iteration are stored in the storage regions Aᵢ and Sᵢ.

In this way, by repeating the iterative estimations of the iterative estimators 101 for i=1 . . . L (step S307), values with a higher accuracy than the initial values set in the matrices S₁ . . . S_{L} as well as the matrices A₁ . . . A_{L} in steps S302 and S303 are stored in the same regions thereof.

By testing these values it is then determined whether or not the convergence condition has been satisfied. If the convergence condition has not been satisfied, the process returns to step S304 and continues to be repeated (step S308).

On the other hand, if the convergence condition has been satisfied, the results output component 103 solves for the mixing ratio matrix A by taking the matrix product (step S309)

A=A₁A₂ . . . A_{L-1}A_{L}

and additionally solves for the noise matrix N by performing matrix arithmetic (step S310)

N=X−AS

and outputs these results by storing the matrices A, S (=S_{L}), and N in the RAM or similar memory (step S311), ending the process. Thus, the CPU, working in conjunction with the RAM or similar memory, functions as the results output component.

The iterations described above are equivalent to conducting signal separation in the following manner. In order to ease understanding, expressions relating to the noise matrix have been omitted from the following derivation.

$$X = \\ {S}_{0} = {A}_{1} {S}_{1} ;$$

$${S}_{1} = {A}_{2} {S}_{2} ;$$

$${S}_{2} = {A}_{3} {S}_{3} ;$$

$$…$$

$${S}_{L - 2} = {A}_{L - 1} {S}_{L - 1} ;$$

$$\begin{matrix}{S}_{L - 1} = {A}_{L} {S}_{L} \\ = {A}_{L} S\end{matrix}$$

To summarize, this can be expressed as the following:

$$\begin{matrix}X = {A}_{1} {A}_{2} {A}_{3} … {A}_{L} S \\ = AS\end{matrix}$$

The matrix product in step S309 is equivalent to solving for the matrix A as shown above.

Predefined Matrix Operation

In the foregoing embodiment, the matrix product is used as the predefined matrix operation c(x,y). More specifically, consider a matrix Z having i rows and t columns and elements Z[i,t]. If the number of rows of the matrix Z is written as row(Z) and the number of columns of the matrix Z is written as col(Z), then for the matrices Z and W existing in a relationship such that col(Z)=row(W), there exists a predefined operation defined as

c(Z,W)[i,t]=Σₖ₌₁^{col}(Z)Z[i,k]W[k,t]

In the case where a matrix convolution operation is considered as the operation c(x,y), then a tensor operation taking into account two-dimensional matrices (i.e., second order tensor) and three-dimensional matrices (i.e., third order tensor) is to be conducted. The matrix subject to this convolution operation is referred to as the mixing operator.

While the observed signal matrix X and the source signal matrix S are two-dimensional matrices as shown above, the mixing ratio matrix A is a three-dimensional matrix. The elements of a three-dimensional matrix are expressed in the form [x, y, z] similar to the above. In addition, in accordance with tensor convention, the values of regions where elements are undefined are taken to be 0, and the subscript of Σ indicates that a sum is to be taken over the entire indicated range of the indices in the tensor.

In so doing, a convolution of a third-order tensor A and a second-order tensor S is defined as shown in Equation 1.

$$c ( A , S ) [ i , t ] = {\sum }_{k} {\sum }_{s = - ∞}^{∞} A [ i , k , s ] S [ k , t - s ] \qquad Equation 1$$

Likewise, a convolution of a third-order tensor A and a third-order tensor B is defined as shown in Equation 2.

$$c ( A , B ) [ i , t , r ] = {\sum }_{k} {\sum }_{s = - ∞}^{∞} A [ i , k , s ] S [ k , j , r - s ] \qquad Equation 2$$

In addition, in the case where a nonlinear link function is used, an operation such as

c(A,S)[i,t]=f(ΣₖZ[i,k]W[k,t])

For the function f(x), typically a step function that is smooth in the vicinity of the origin like that often used in the field of neural networks may be used. For example, a function such as

f(x)=2 arctan(kx)/π

may be used, where k is sufficiently large. Typically, however, it is possible to apply an arbitrary nonlinear function.

Hereinafter, the results of a variety of tests comparing the foregoing embodiment with conventional techniques will be described. All of the following tests were conducted via computer simulation.

Test 1 involves comparing signal separations corresponding to sound waves emitted from a plurality of sound sources (more commonly, the propagation of a source signal emitted from a signal source) as collected by a microphone positioned nearby (more commonly, the observed signal obtained by observing the propagation with a receiver or sensor). In the following, testing is conducted using benchmark data used in the field of signal separation obtained by NMF (Non-negative Matrix Factorization).

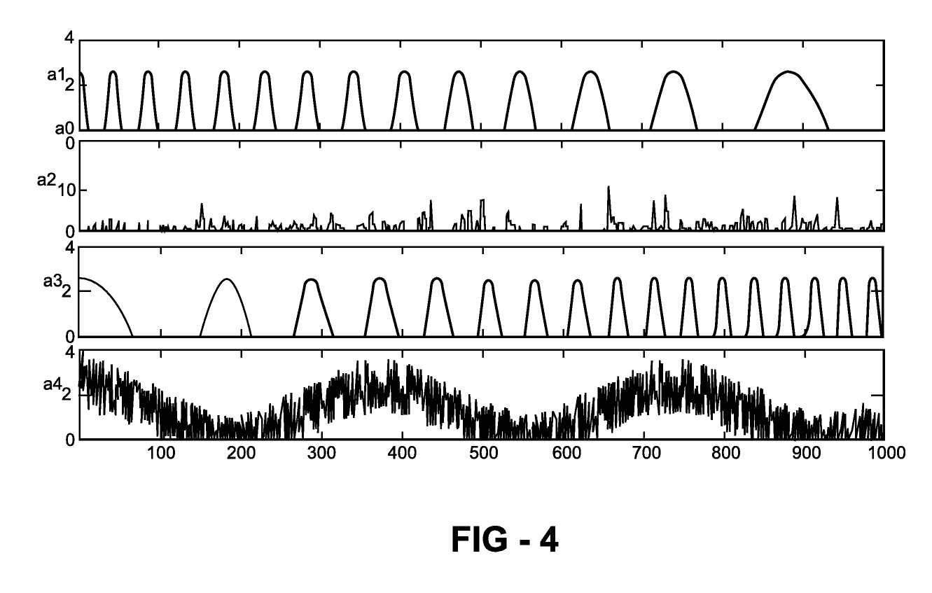

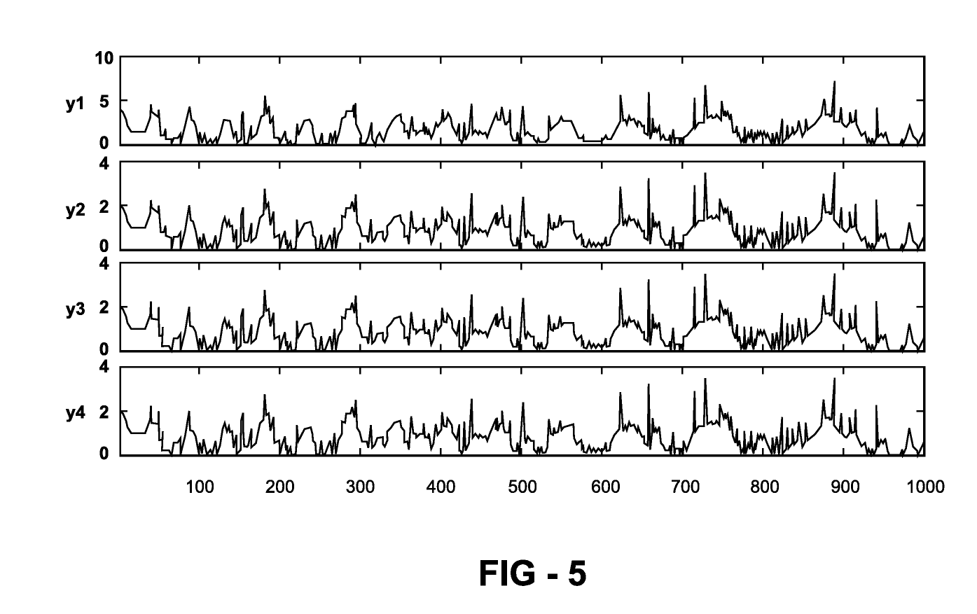

FIG. 4 is a graph showing the nature of the waveforms of the source signal. FIG. 5 is a graph showing the nature of the waveforms of the observed signal.

If the waveforms of the source signal in FIG. 4 are mixed using a Hilbert matrix with a condition number of approximately 15000, then an observed signal can be obtained like that shown in FIG. 5, with mutually similar waveforms.

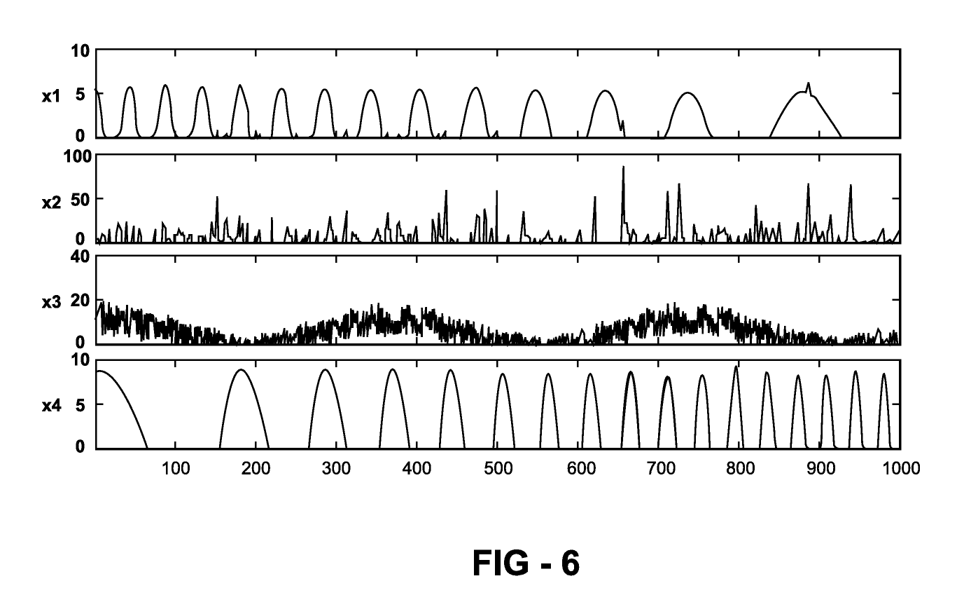

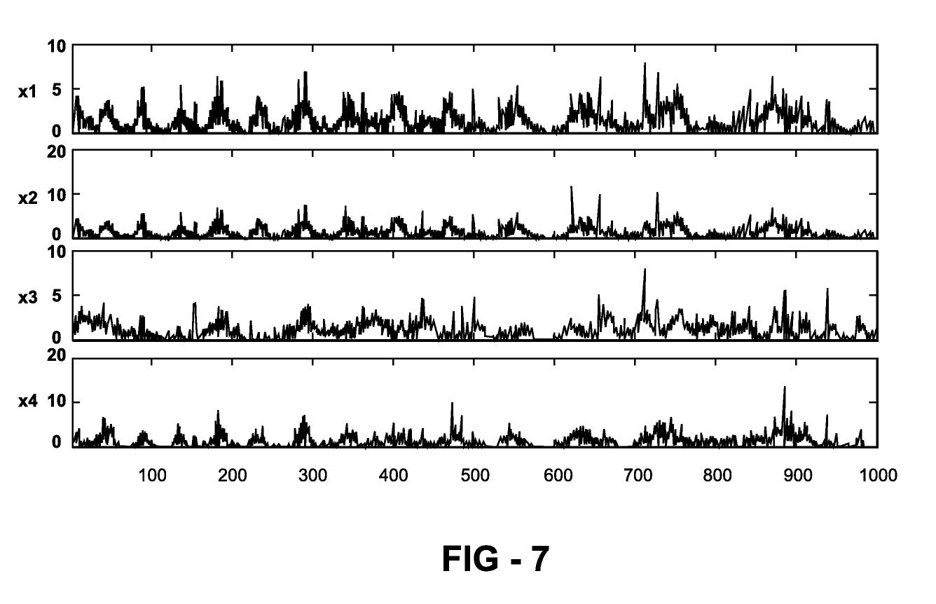

FIG. 6 is a graph of the waveforms in the case where independent component analysis is conducted on the four signals via the technique of the present embodiment, using the conjugate gradient method with L=10. By contrast, FIG. 7 is a graph of the waveforms in the case where independent component analysis is conducted on the four signals via the conventional technique.

In the conventional technique (FIG. 7), the signal is resolved into components that are entirely different from those of the original waveforms (FIG. 4). However, it can be seen that by using the technique of the present embodiment (FIG. 6), a signal is obtained that is extremely close to the original waveforms (FIG. 4).

Test 2 illustrates signal separation in the case where a large amount of noise is present.

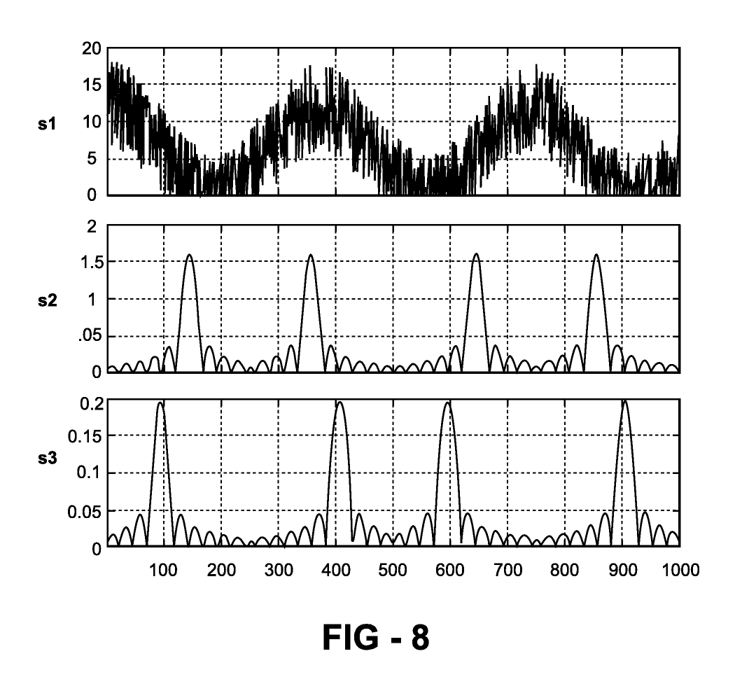

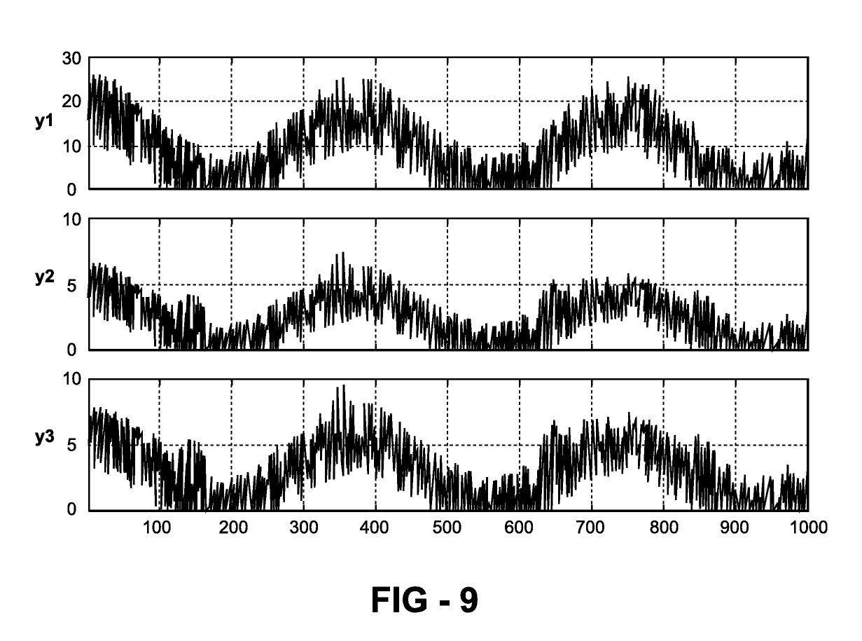

FIG. 8 is a graph showing the nature of the waveforms of the source signal. FIG. 9 is a graph showing the nature of the waveforms of the observed signal.

As shown in the upper part al of FIG. 8, the noise level is very high, and thus it can be seen that noise is also present in the observed signal, as shown in FIG. 9.

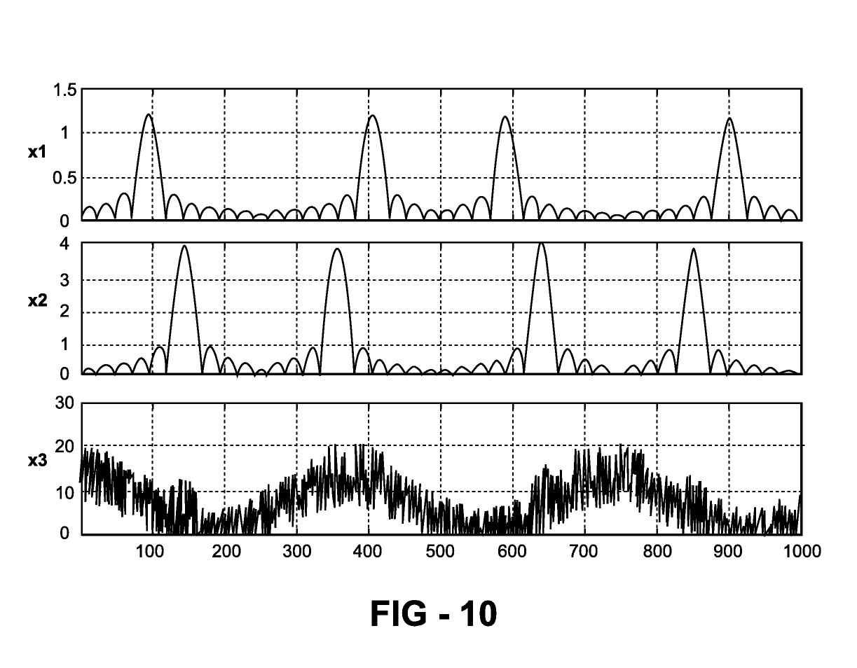

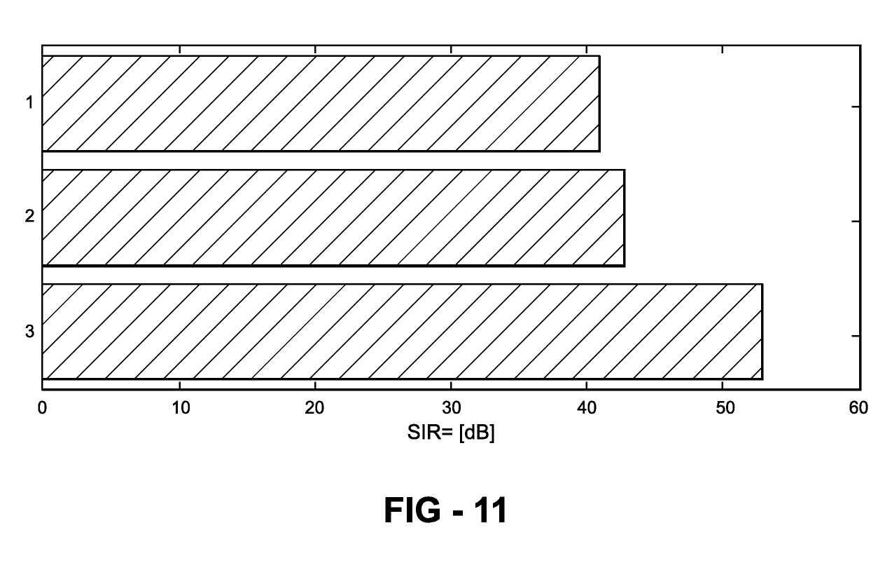

FIG. 10 is a graph of the waveforms obtained via the technique of the present embodiment, wherein the iterative estimators use Amari's α-divergence NMF algorithm with L=5. FIG. 11 is a graph showing SIR (Signal to Interference Ratio) values.

Compared to FIG. 8, it can be seen that an extremely similar signal is obtained, and additionally, quality is favorable with SIR values of approximately 40 dB to 53 dB.

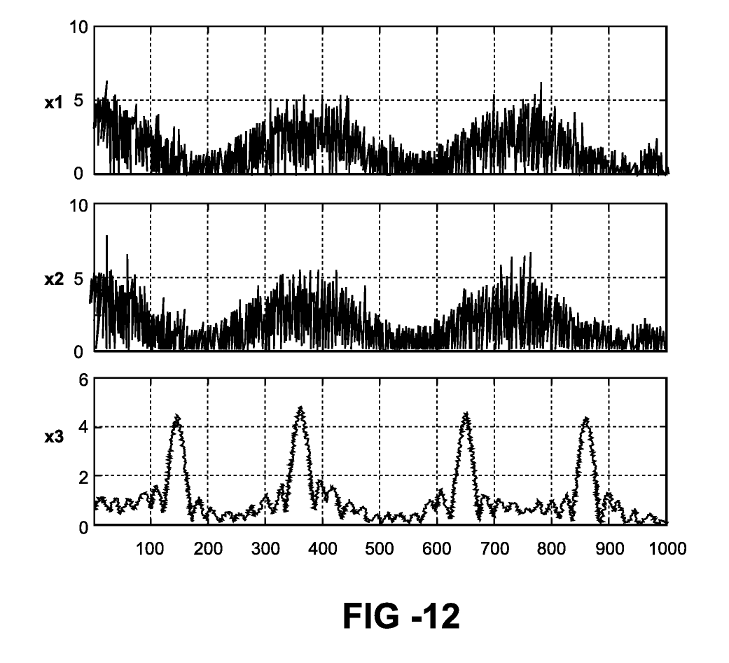

FIG. 12 shows a graph of the waveforms obtained using the conventional technique of the NMF Lee-Seung algorithm.

The conventional technique yields SIR values of less than 8 dB, and thus the high capability of the technique of the present embodiment is apparent.

Test 3 is an application to image processing.

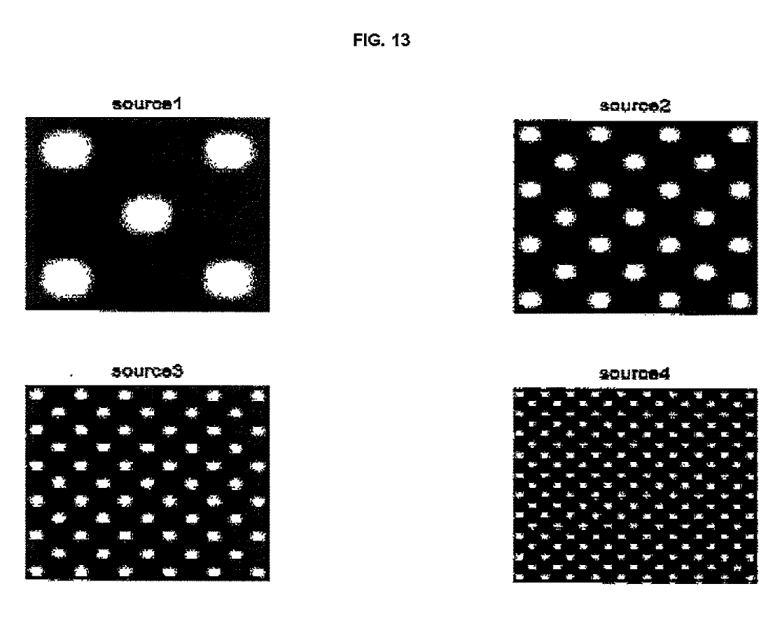

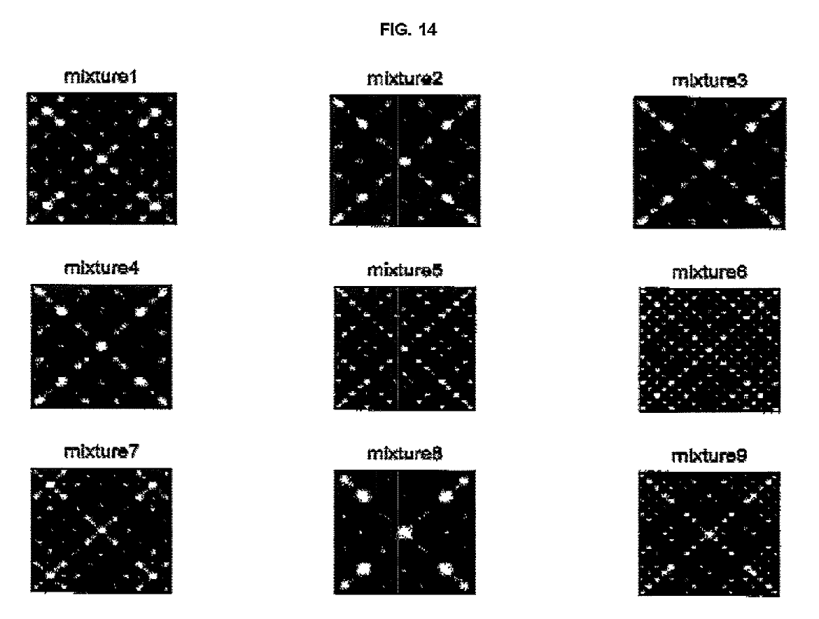

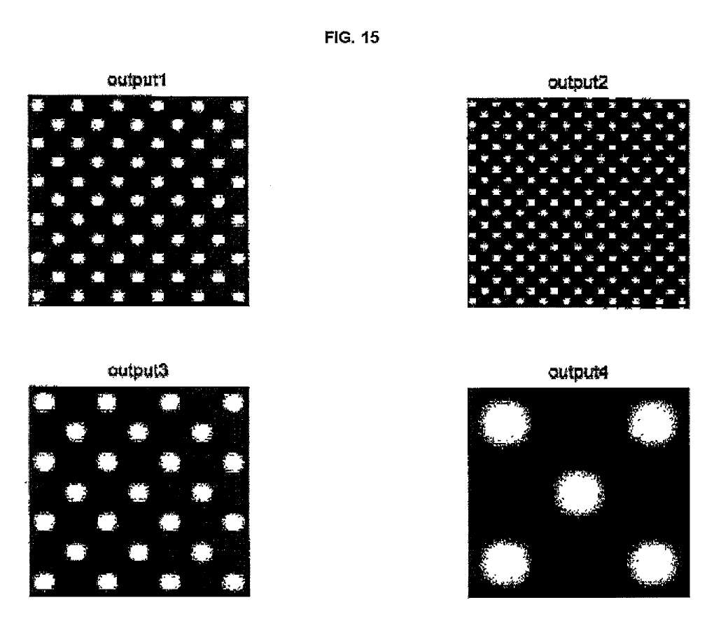

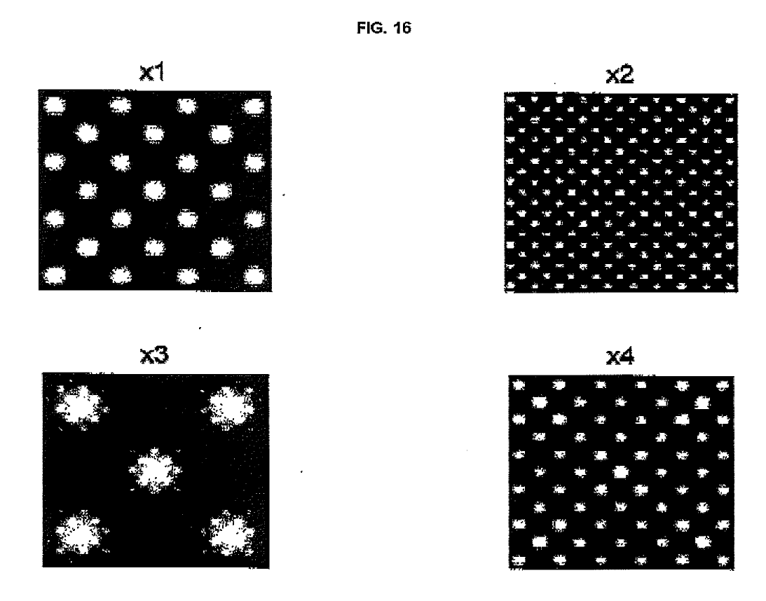

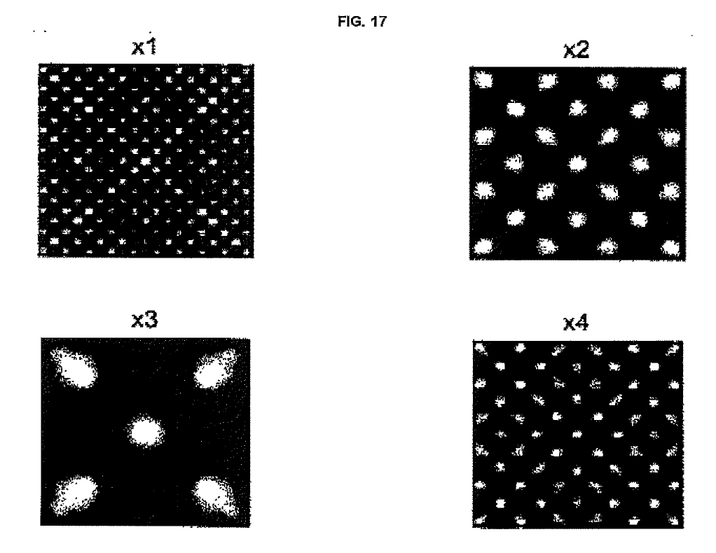

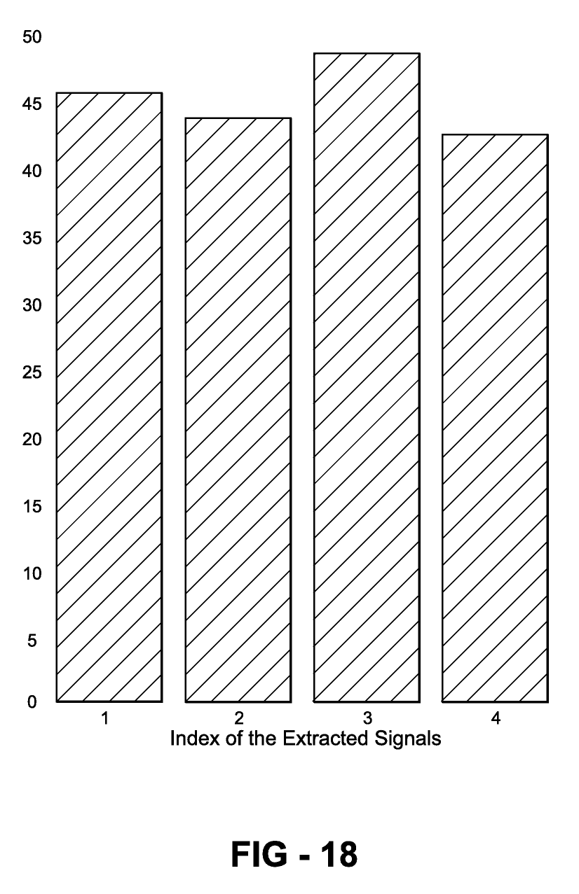

FIG. 13 is a diagram showing the images which act as the source signal. FIG. 14 is a diagram showing the images corresponding to the observed signal. FIG. 15 shows the nature of the source signal obtained in the case where the technique of the present embodiment is adopted with L=5. FIG. 16 shows the nature of the source signal obtained in the case wherein the technique of the present embodiment is adopted with L=2. FIG. 17 shows the source signal images obtained using the conventional technique of the NMF Lee-Seung algorithm. FIG. 18 is a graph showing the SIR values of the signal from the technique of the present embodiment.

As shown in FIG. 13, there are four source signals, and as shown in FIG. 14, these are observed using nine channels.

Using independent component analysis via the technique of the present invention with L=5 restores the source signal nearly perfectly, as shown in FIG. 15. SIR values are approximately 46 dB, as shown in FIG. 18.

Meanwhile, using independent component analysis via the technique of the present invention with L=2 results in insufficient separation and low SIR values of less than 15 dB. The effect of increasing the value of L is thus clearly displayed.

The results of separation via the conventional technique are shown in FIG. 17. As expected, separation is insufficient, and the SIR values are less than 10 dB.

Multimedia Information Providing System

On the basis of the underlying techniques described above, a multimedia information providing system in accordance with an embodiment of the present invention will hereinafter be described in detail.

In the present embodiment, the high-performance signal separation device 100 as described above is implemented as the component analysis technique, thereby enabling the utilization of the foregoing variety of signal separation techniques.

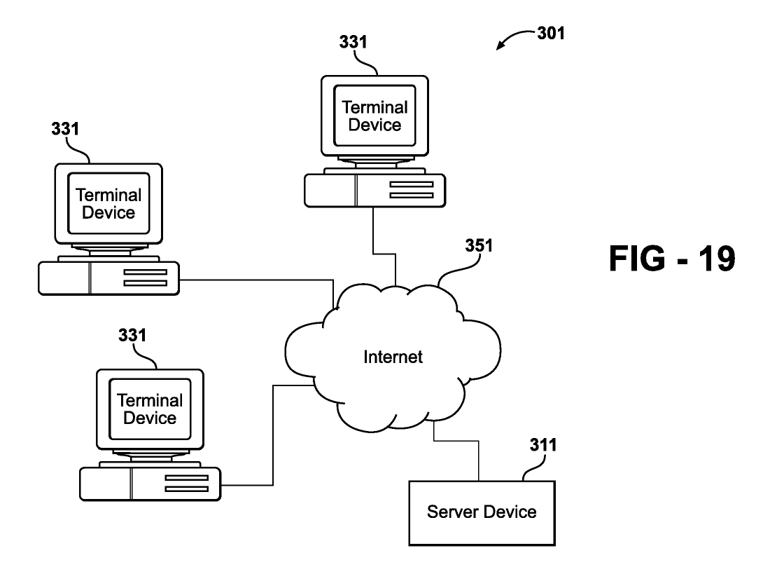

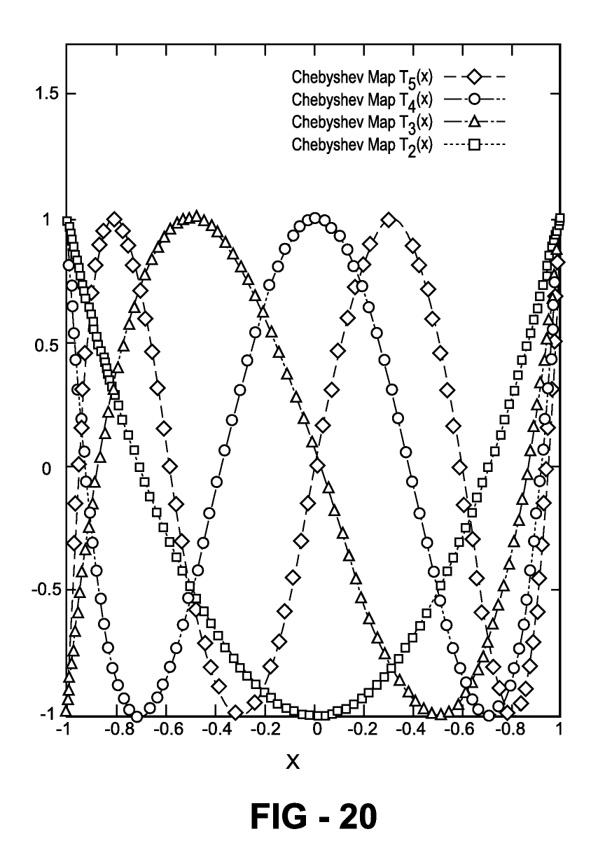

FIG. 19 is an explanatory diagram illustrating the schematic configuration of the multimedia information providing system in accordance with the present embodiment. The description hereinafter will refer to this diagram.

A multimedia information providing system 301 in accordance with the present embodiment includes a server device 311 and a terminal equipment 331. Both devices are communicably connected via a computer communications network 351 such as the Internet.

Ordinarily, the terminal equipment 331 is realized as a personal computer or game device used by a typical user to access the Internet, and the server device 311 is realized as a server computer such as web server or an accounting and payment server that is accessed by a terminal equipment 331 like the above.

The server device 311 provides a variety of multimedia information, such as audio, still images, moving images, and 3D images to the terminal equipment 331. Typically, low-quality multimedia information is provided for preview purposes, and when the user of the terminal equipment 331 desires to purchase the information, a higher quality version of the information is provided. “Preview” herein also includes sample listening of audio information as well as the viewing of moving images and still images, and is hereinafter used in such a sense.

Although the multimedia information providing system 301 in accordance with the present embodiment uses a random number sequence based on a chaotic sequence, the description hereinafter will involve a system using Chebyshev polynomials as such a chaotic sequence by way of example in order to ease understanding.

FIG. 20 is a graph illustrating the nature of Chebyshev polynomials. The description hereinafter will refer to this diagram.

A Chebyshev polynomial Tₐ(x) of degree a (a≧2) is defined as

Tₐ(cos θ)=cos(aθ)

or more concretely as

T₂(x)=2x²−1;

T₃(x)=4x³−3x;

. . .

As shown in the diagram, a Chebyshev polynomial y=Tₐ(x) of second degree or higher is a rational map that maps {x|−1<x<1} to {y|−1<y<1}.

Iteratively applying such a Chebyshev polynomial to an initial value x(−1<x<1) yields a matrix of the form

x, F(x), F(F(x)), F(F(F(x))),

referred to as a chaotic sequence. Such a sequence is known for having a variety of properties advantageous as a random number, such as the fact that this sequence does not cycle when calculated with unlimited precision, and its cycle is extremely long even when calculated with limited precision.

A random number sequence of the form

x₁, x₂, x₃, . . .

can be expressed using recurrence equations like the following:

x₁=x;

xᵢ₊₁=F(xᵢ) (i≧1);

and can thus be easily calculated using iterative calculation via a computer or similar means.

Moreover, this chaotic random number is distributed evenly between the given limits, and it can be seen that a density function ρ(x) like the following can be obtained:

ρ(x)=1/[π(1−x²)^{1/2}]

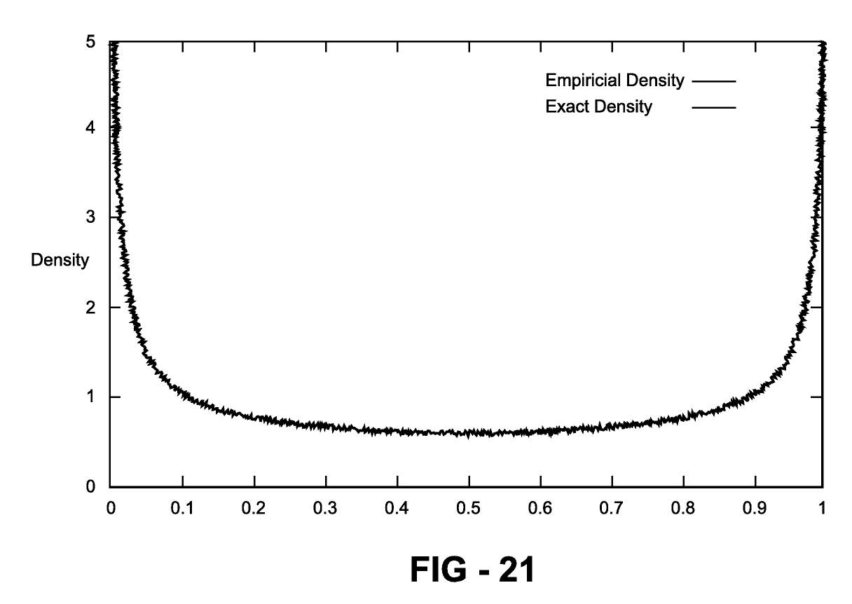

FIG. 21 is a graph illustrating the distribution up to a certain point of a chaotic random number generated using a Chebyshev polynomial provided with an initial value suitable in practice.

The numerical values included in the above random number sequence are values in the range from −1 to 1. The values in the diagram, however, have been displaced to the range from 0 to 1 by adding 1 and dividing the result by 2. The horizontal axis corresponds to the obtained random number values, while the vertical axis corresponds to the frequency in which a random number appears divided by the total length of the sequence (i.e. the relative frequency).

As shown in the diagram, it can be seen that a distribution is obtained that is similar to the limit distribution expressed by the above ρ(x).

In this way, there exist various, analytically expressible chaotic random numbers in the limit distribution. In other words, although the Chebyshev polynomials are obtained by using trigonometric addition theorems, a random number sequence to be used in the noise signal may also be generated by using set parameters applied to other maps, such as rational mappings derived from elliptic function addition theorems (in particular, Ulam-von Neumann maps, cubic maps, and quintic maps) or alternatively, Katsura-Fukuda maps, generalized Ulam-von Neumann maps, generalized cubic maps, or generalized Chebyshev maps.

As described above, in the present embodiment a chaotic sequence is taken to be a sequence of random number values, the chaotic sequence obtained by iteratively applying a function F(x) with respect to a given initial value. However, in the opposite case, one can also consider the degree to which a number sequence of given length M

s₁, s₂, s₃, . . . , s_{M}

exhibits the characteristics of a chaotic sequence. In other words, one can consider a characteristic quantity that expresses the degree to which a sequence resembles, or does not resemble, a chaotic sequence.

Typically, quantities such as the correlation dimension or the maximal Lyapunov exponent, which indicate the chaotic properties of a number sequence, can be adopted as such a characteristic quantity. For either of these numerical values, a system can be considered to be chaotic to the degree that the value is large.

For example, the maximal Lyapunov exponent of a number sequence

s₁, s₂, s₃, . . . , s_{M}

is already known in the case where a function F(x) is used to generated the chaotic sequence, and thus is easily calculated.

In the case where the function F(x) is not known, it is possible to estimate the dynamical Jacobian involved in the generation of the chaotic sequence from the number sequence

s₁, s₂, s₃, . . . , s_{M}

and then solve for the maximal Lyapunov exponent on the basis thereof.

In addition, it is also possible to solve for the distribution of the number sequence

s₁, s₂, s₃, . . . , s_{M}

in the case where the shape of the limit distribution is fixed. It is then possible to investigate to what degree the sequence resembles a chaotic sequence according to differences in shape between this distribution and the limit distribution.

Furthermore, since in the present embodiment a chaotic sequence is generated using recurrence equations, the degree to which a number sequence

s₁, s₂, s₃, . . . , s_{M}

resembles a chaotic sequence may also be given as the error

εᵢ=sᵢ₊₁−F(sᵢ) (1≦i≦M−1)

and thus solved easily.

Since the chaotic sequence is generated by recurrence equations using F(x), if the number sequence

s₁, s₂, s₃, . . . , s_{M}

resembles this chaotic sequence, then for two adjacent elements sᵢ and sᵢ₊₁ in the number sequence, the following should hold true:

sᵢ₊₁≈F(sᵢ)

Thus, quantities such as

(1) the sum of the error: Σᵢ₌₁^{M-1}|εᵢ|;
(2) the average of the error: Σᵢ₌₁^{M-1}|εᵢ|/(M−1);
(3) the weighted average of the error: Σᵢ₌₁^{M-1}ωᵢ|εᵢ|/(M−1);
(4) the sum of the squares of the error: Σᵢ₌₁^{M-1}εᵢ²;
(5) the average of the squares of the error: Σᵢ₌₁^{M-1}εᵢ²/(M−1); and
(6) the weighted average of the squares of the error: Σᵢ₌₁^{M-1}ωᵢεᵢ²/(M−1);
or a numerical value such as the standard deviation of the error can be considered as the characteristic quantity that expresses the degree to which a sequence resembles a chaotic sequence. Herein, the term ωᵢ is a suitable positive weighting value.

Thus with a technique using the error between adjacent elements, a number sequence resembles a chaotic sequence and exhibits the characteristics of a chaotic sequence to the degree that the numerical value of the above characteristic quantity is small.

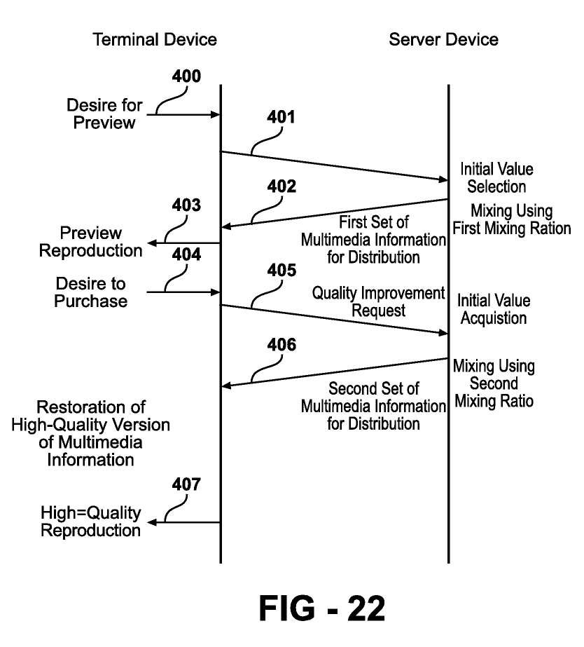

FIG. 22 is a session diagram illustrating the nature of communication between the server device 311 and the terminal equipment 331 of the multimedia information providing system 301. The description hereinafter will refer to this diagram.

The provision of multimedia information in the present embodiment is commenced the moment when a preview request is transmitted from the terminal equipment 331 to the server device 311 (401), based on a desire for preview from a user (400).

Various methods may be considered for this preview request, such as for example by e-mail, or the transmission of a request via a CGI (Common Gateway Interface) script prepared in advance and accessed by a web browser at a specified URL (Uniform Resource Locator).

Upon receiving the preview request, the server device 311 generates a first set of multimedia information for distribution to provide to the terminal equipment 331, and then transmits this information (402).

The first set of multimedia information for distribution is mixed with a noise signal as described hereinafter, and thus low in quality. For this reason, while such information can be used for preview purposes, it is ultimately a low-quality set of multimedia information for preview, and thus no problem is posed even if a third party eavesdrops on or snoops such information.

Having received the first set of multimedia information for distribution, the terminal equipment 331 reproduces and causes the user to preview this information (403). In the case where the user decides to purchase a higher-quality version of the information as a result of the preview (404), a quality improvement request is transmitted to the server device 311 by the terminal equipment 331 (405).

Upon receiving the quality improvement request, the server device 311 generates a second set of multimedia information for distribution to provide to the terminal equipment 331, and then transmits this information (406).

Similarly to the first set of multimedia information for distribution, the second set of multimedia information for distribution is mixed with a noise signal and therefore low in quality. For this reason, while the second set of multimedia information for distribution can also be used for preview purposes, it is ultimately a low-quality set of multimedia information for preview, and thus no problem is posed even if a third party eavesdrops on or snoops such information.

For identical, high-quality multimedia information, the first set of multimedia information for distribution and the second set of multimedia information for distribution are mixed with identical noise signals, but wherein the mixing ratios are different.

At this point, it is desirable to assume that there are a plurality of terminal equipments 331, and that for each terminal equipment 331 (or alternatively, for each user using a terminal equipment 331), a different noise signal is used. For this reason, information for identifying the noise signal (typically, an initial value corresponding to the random number seed for generating the noise signal) is associated and saved with an identification code of (the user of) the terminal equipment 331 at the time of the provision of the first set of multimedia information.

Information such as the following, including combinations thereof, may be used as the identification code of (the user of) the terminal equipment 331: the user's own personal information (membership number, e-mail address, etc.), the MAC (Media Access Control) address of a network interface card which the terminal equipment 331 has, a CPU ID (IDentifier) assigned to the CPU (Central Processing Unit) of the terminal equipment 331, and the serial number of an application or the OS operating on the terminal equipment 331. In this case, it is typical to transmit the identification code from the terminal equipment 331 to the server device 311 at the time of the preview request.

On the other hand, another technique may be considered wherein the server device 311 allocates to the terminal equipment 331 a unique identification code, and then transmits this code to the terminal equipment 331 at the time of the provision of the first set of multimedia information for distribution. For example, in the case where a CGI script is used, a technique may be adopted wherein information associated with the identification code is written to a cookie and transmitted from the web browser at the time of the quality improvement request.

Hereinafter, the former technique will be described as a typical example.

If the mixing ratio of the noise signal in the second set of multimedia information for distribution is made larger than the mixing ratio of the noise signal in the first set of multimedia information for distribution, the multimedia information is made to be extremely low in quality. For this reason, even if a third party eavesdrops on or snoops the information, from a practical standpoint the third party will experience nothing but noise. The eavesdropper/snooper will thereby lose interest, yielding further effects of preventing unauthorized use.

Having received the second set of multimedia information for distribution, the terminal equipment 331 is able to reproduce and cause the user to preview this information. However, this usage technique is not typical.

By performing processing to be hereinafter described with respect to the first set of multimedia information for distribution and the second set of multimedia information for distribution, the noise signal is separated, and a set of multimedia information that is higher in quality than these two sets is extracted.

The extracted set of high-quality multimedia information is then reproduced and experienced by the user (407).

Hereinafter, the server device 311 and the terminal equipment 331 will be described in further detail.

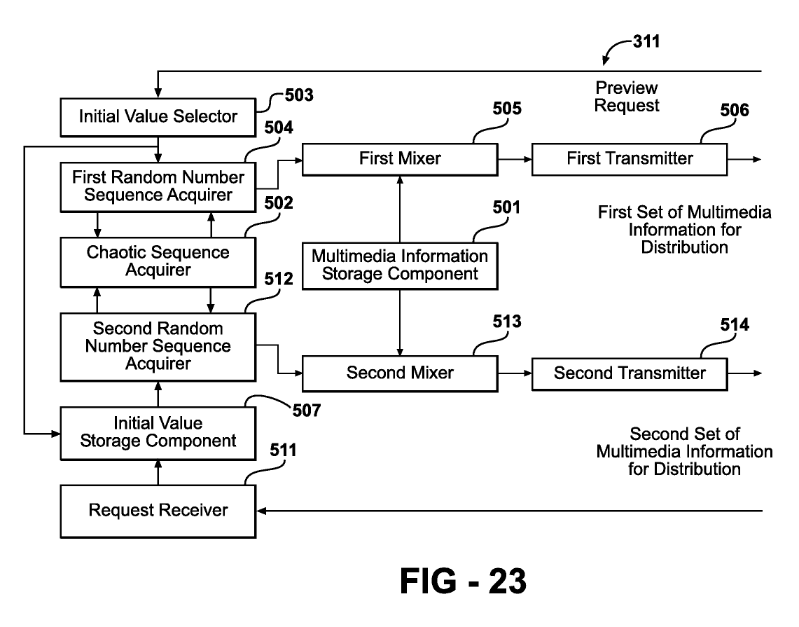

FIG. 23 is an explanatory diagram illustrating the schematic configuration of the server device 311 of the multimedia information providing system 301.

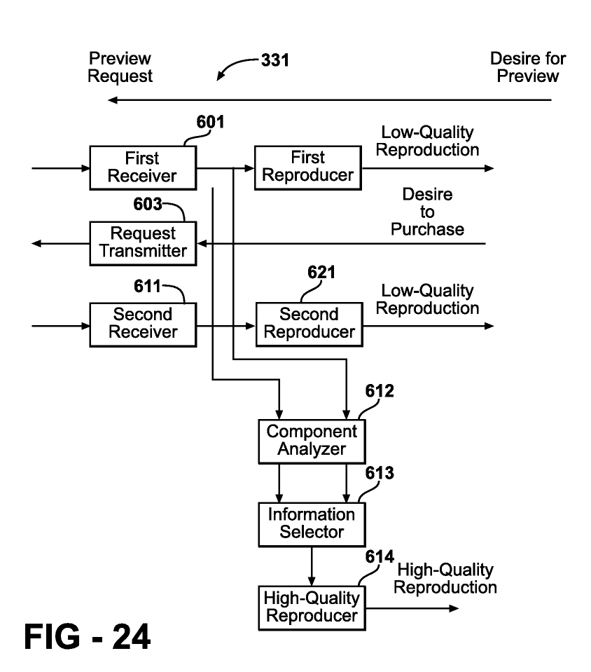

FIG. 24 is an explanatory diagram illustrating the schematic configuration of the terminal equipment 331 of the multimedia information providing system 301.

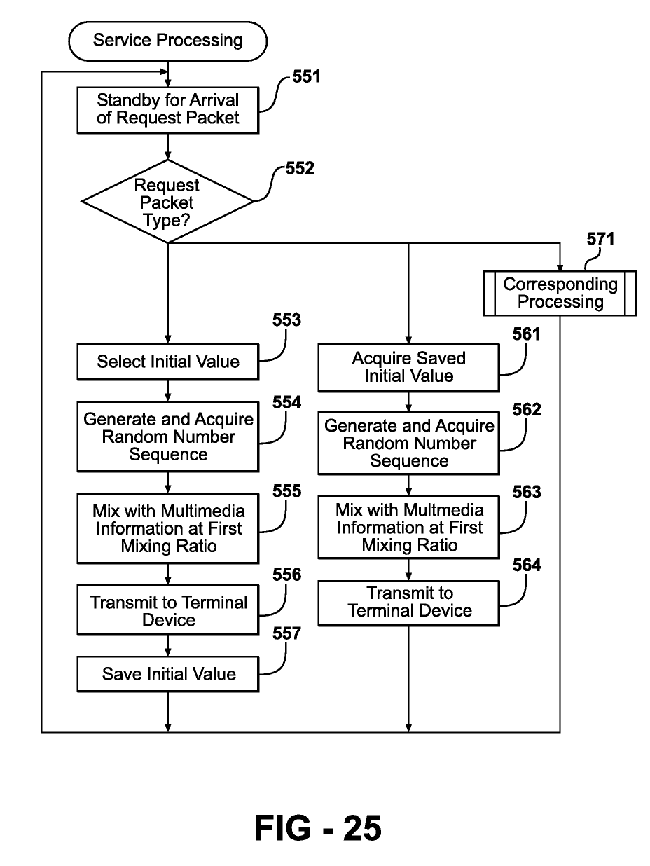

FIG. 25 is a flowchart showing the control flow of the service processing executed on the server device 311 of the multimedia information providing system 301.

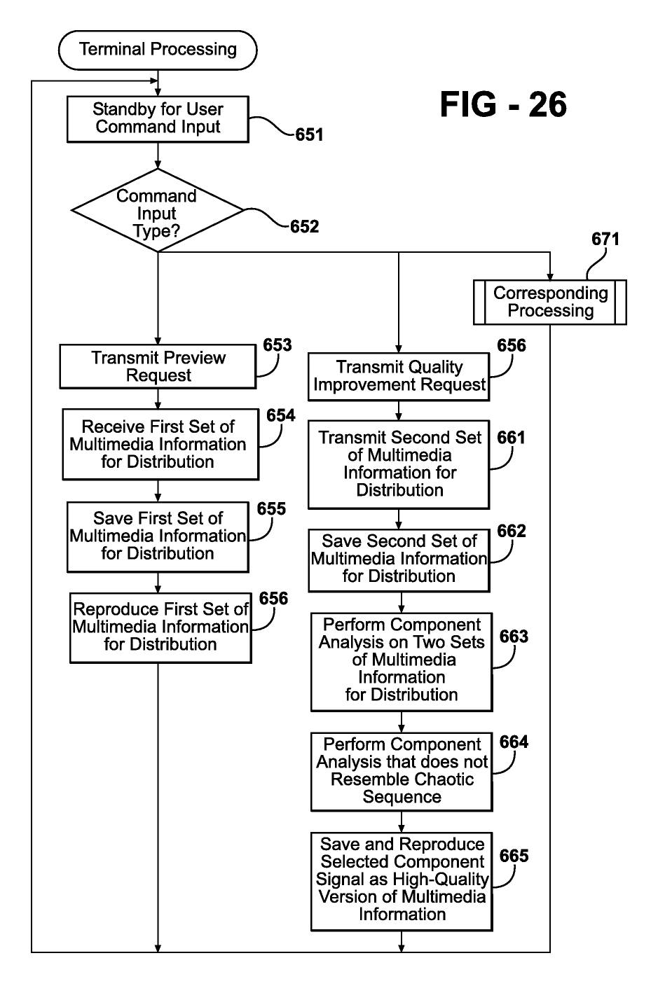

FIG. 26 is a flowchart showing the control flow of the terminal processing executed on the terminal equipment 331 of the multimedia information providing system 301.

The description hereinafter will refer to these diagrams.

As shown in FIG. 23, the server device 311 includes a multimedia information storage component 501, a chaotic sequence generator 502, an initial value selector 503, a first random number sequence acquirer 504, a first mixer 505, a first transmitter 506, an initial value storage component 507, a request receiver 511, a second random number sequence acquirer 512, a second mixer 513, and a second transmitter 514.

Multimedia information, including at least one of audio or image data, is stored in advance in the multimedia information storage component 501 herein.

This information is equivalent to the “master” of a record, wherein the first set of multimedia information for distribution and the second set of multimedia information for distribution are produced from this “master”. In addition, the information of the “master” itself is not restored at the terminal equipment 331; typically, the information that the user is ultimately able to obtain is of slightly lower quality than the “master”.

In addition, although the multimedia information itself can be saved in a compressed form on a hard disk or other means, steps such as the mixing processing to be hereinafter described require the information to be reverted to so-called RAW data first.

Consequently, a storage medium such as a hard disk in a server computer functions as the multimedia information storage component 501.

The service processing executed on the server device 311 is a repeated control, wherein the server device 311 waits for a request packet from the terminal equipment 331, conducts processing according to this request packet, and then transmits the processing results to the terminal equipment 331 as a reply packet.

Thus, upon commencing service processing, the server device 311 operates in standby until various request packets that have been transmitted from respective terminal equipments 331 arrive (step S551). The types of these request packets include preview requests and quality improvement requests, as stated in the foregoing, but types other than these may also be suitably prepared.

As shown in FIG. 24, the terminal equipment 331 is provided with a first receiver 601, a first reproducer 602, a request transmitter 603, a second receiver 611, a component analyzer 612, a information selector 613, a high-quality reproducer 614, and a second reproducer 621.

The terminal processing executed on the terminal equipment 331 is a repeated control, wherein the terminal equipment 331 waits for commands from the user, conducts processing according to these commands, and then provides the processing results to the user.

In other words, in the terminal equipment 331, upon commencing terminal processing, the terminal equipment 331 operates in standby until there is command input from the user (step S651). When there is command input, the terminal equipment 331 looks up the type of input (step S652).

If the type of input is one seeking a preview of multimedia information (step S652; Preview), then the terminal equipment 331 transmits to the server device 311 a preview request as a request packet (step S653), the preview request specifying an identification code identifying (the user of) the terminal equipment 331 and the identification code of the multimedia information sought.

When there exists a request packet that has arrived, the server device 311 looks up the type of the request packet (step S552). If the type of request packet is a preview request (step S552; Preview), then the initial value selector 503 of the server device 311 selects an initial value to be associated with the identification code of (the user of) the terminal equipment 331 (step S553).

The initial value selected in step S553 is the value used as the initial value of the chaotic sequence.

The selection of the initial value is conducted randomly based on information such as the current time, the transmission time of the request packet, the identification code of the terminal equipment 331 or the user specified in the request packet, or another random number sequence, being selected such that initial values are not duplicated as little as possible. Consequently, the CPU of the server device 311 functions as the initial value selector 503.

The chaotic sequence generator 502 of the server device 311 then generates a random number sequence derived from a chaotic sequence, taking the value provided as input as the initial value thereof. As described above, by using recurrence equations to iteratively apply a function F(x) to an input numerical value, a chaotic sequence of arbitrary length is output as a random number sequence. Since the calculation for obtaining the chaotic sequence is deterministic, the same chaotic sequence will be always obtained if the same numerical value is provided as input.

Consequently, the CPU provided in the server device 311, working in conjunction with the RAM (Random Access Memory) or similar memory used for storing intermediate values and the results of calculations, functions as the chaotic sequence generator 502.

When the initial value selector 503 selects an initial value for (the user of) the terminal equipment 331, the first random number sequence acquirer 504 provides the selected initial value as input into the chaotic sequence generator 502, and acquires the random number sequence generated thereby (step S554). It is typical for the length of the random number sequence calculated herein to be the same length as the RAW data of the multimedia information sought for preview.

Consequently, the CPU, working in conjunction with the RAM or similar memory, functions as the first random number sequence acquirer 504.

Subsequently, the first mixer 505 mixes the random number acquired by the first random number sequence acquirer 504 as a noise signal into the stored multimedia information at a first mixing ratio, thereby obtaining a first set of multimedia information for distribution (step S555).

The mixing referred to herein involves outputting the product of multiplying each bit in the RAW data of the multimedia information by a certain constant and also multiplying each bit in the noise signal by another constant. The ratio of these two constants is the mixing ratio.

It is preferable that the first mixing ratio be suitable for preview. In addition, since it is necessary for the first mixing ratio to be different from the second mixing ratio to be hereinafter described, the first mixing ratio and the second mixing ratio may also be obtained by generating two different numerical values from the identifier of (the user of) the terminal equipment 331, multiplying these numerical values by very small coefficients, and then adding the result to a basic mixing ratio established in advance.

After being mixed as RAW data, it is typical to apply appropriate, listenable or viewable, reversible or non-reversible compression algorithms. By suitably compressing the data, the first set of multimedia information for distribution is obtained.

Consequently, the CPU, working in conjunction with the RAM or similar memory, functions as the first mixer 505.

Subsequently, the first transmitter 506 transmits to the terminal equipment 331 the obtained first set of multimedia information for distribution as a reply packet corresponding to the request packet of the preview request (step S556).

It is typical to adopt a streaming distribution protocol for the provision of the first set of multimedia information for distribution, so that the terminal equipment 331 can commence reproduction immediately. However, since this information will also be used later in order to restore the high-quality set of multimedia information, the first set of multimedia information for distribution is provided in a savable format.

Consequently, the CPU, working in conjunction with the RAM, network interface card, and similar components, functions as the first transmitter 506.

Subsequently, the initial value storage component 507 associates and stores the initial value selected in step S553 with the identification code of (the user of) the terminal equipment 331 or the identification code of the multimedia information requested by the preview request (typically, this is identical to the identification code identifying the first set of multimedia information for distribution, or common to a degree such that the two codes are mutually convertible) (step S557). The process then returns to step S551.

Consequently, the initial value storage component 507 can by realized by some type of database. In other words, the CPU and RAM, working in conjunction with a hard disk, function as the initial value storage component 507.

The first receiver 601 of the terminal equipment 331 then receives the first set of multimedia information for distribution as a reply corresponding to the preview request transmitted to the server device 311 in step S653 (step S654).

Consequently, the CPU of the terminal equipment 331, working in conjunction with a network interface card and the RAM or similar memory, functions as the first receiver 601.

The first reproducer 602 then saves (step S655) and reproduces (step S656) the received first set of multimedia information for distribution. The process then returns to step S651.

This reproduction is conducted in response to the user's command input indicating desire to preview the information.

As described above, it is typical for the first set of multimedia information for distribution to be streamed, but since this information is necessary later for restoring the high-quality set of multimedia information, the entirety of the first set of multimedia information for distribution is received and saved in a storage medium such as a hard disk.

Consequently, the CPU, working in conjunction with components such as the RAM, hard disk, and monitor, f and similar components, functions as the first reproducer 602.

In the case where the user, having listened to or viewed the first set of multimedia information for distribution as a preview, desires to purchase the multimedia information (including cases where there is no additional cost), command input is given in step S651 indicating a purchase is sought. When the CPU of the terminal equipment 331 detects the presence of command input indicating a purchase is sought (step S652; Purchase), the request transmitter 603 transmits to the server device 311 a quality improvement request as a request packet, the quality improvement request requesting a second set of multimedia information that is a higher quality version of the first set of multimedia information for distribution (step S656).

In this request packet is specified the identification code of (the user of) the terminal equipment 331, as well as information such as an identification code identifying the first set of multimedia information for distribution. Consequently, the CPU, working in conjunction with components such as the RAM and a network interface card, and similar components, functions as the request transmitter 603.

Upon doing so, the request receiver 511 of the server device 311 receives the quality improvement request transmitted from the terminal equipment 331 as a request packet in step S551, and thus the type of the request packet becomes a quality improvement request (step S552; Quality Improvement).

Upon doing so, the CPU acquires, from among the initial values saved in the initial value storage component 507 in step S557, the value that was saved in association with the identification code of (the user of) the terminal equipment 331 specified in the quality improvement request, as well as with the identification code identifying the first set of multimedia information for distribution (step S561).

The second random number sequence acquirer 512 then provides the initial value acquired from the initial value storage component 507 as input into the chaotic sequence generator 502, and acquires the random number sequence generated thereby (step S562).

The random number sequence thus obtained is identical to that obtained in step S554, since the initial value provided as input is the same. Consequently, the CPU, working in conjunction with components such as the RAM and hard disk, or similar memory, functions as the second random number sequence acquirer 512.

Subsequently, the second mixer 513 mixes the random number acquired by the second random number sequence acquirer 512 as a noise signal into the stored multimedia information at a second mixing ratio that is different from the first mixing ratio, thereby obtaining a second set of multimedia information for distribution (step S563).

The processing conducted herein is similar to that of step S555, but as described above, the mixing ratios are different. Consequently, the CPU, working in conjunction with the RAM or similar memory, functions as the second mixer 513.

Furthermore, the second transmitter 514 transmits the obtained second set of multimedia information for distribution as a reply packet to the terminal equipment 331 (step S564). The process then returns to step S551.

The processing conducted in step S564 is similar to that of step S556. Consequently, the CPU, working in conjunction with components such as the RAM and a network interface card, and similar components, functions as the second transmitter 514.

Besides the above, in the case where the request packet is of another type (step S552; Other), corresponding processing is executed (step S571), and then the process returns to step S551.

In the terminal equipment 331, the second receiver 611 receives the second set of multimedia information for distribution transmitted from the server device 311 as a reply corresponding to the request packet of the quality improvement request transmitted in step S656 (step S661). This second set of multimedia information for distribution is then saved to a hard disk or similar storage component (step S662). Moreover, at this point the second reproducer 621 may also reproduce the received second set of multimedia information for distribution (not shown).

Consequently, the CPU, working in conjunction with components such as the RAM, hard disk, and monitor, and similar components, functions as the second reproducer 621.

The component analyzer 612 then takes the first set of multimedia information for distribution and the second set of multimedia information for distribution as input signals and performs component analysis, thereby obtained two component signals (step S663). Although it is typical to use multi-step independent component analysis as described above in the component analysis, it is also possible to utilize the above-described variety of component analysis techniques.

Consequently, the CPU, working in conjunction with components such as the RAM and hard disk, or similar memory, functions as the component analyzer 612. Hereinafter, the kinds of signals that are obtained by using such component analysis will be described.

The case wherein the function F(x) used in the chaotic sequence generator 502 of the server device 311 is a second-order Chebyshev polynomial T₂(x), and the multimedia signal is an audio signal will be considered.

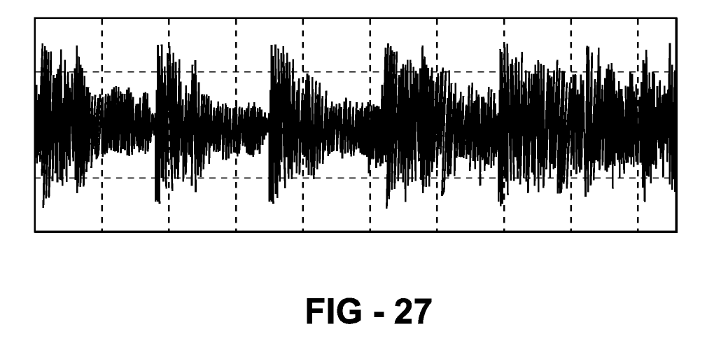

FIG. 27 is an explanatory diagram illustrating the nature of a waveform stored as an original multimedia signal in the multimedia information storage component 501 of the server device 311. As shown in the diagram, while the waveform varies in the first half and the latter half, the overall height of the sound is the same (in actuality, the number of instruments played are increased in the latter half).

The case will be considered wherein an initial value of 0.2, a first mixing ratio of audio to noise equal to 9:1, and a second mixing ratio of audio to noise equal to 8:2 are selected with respect to the above signal.

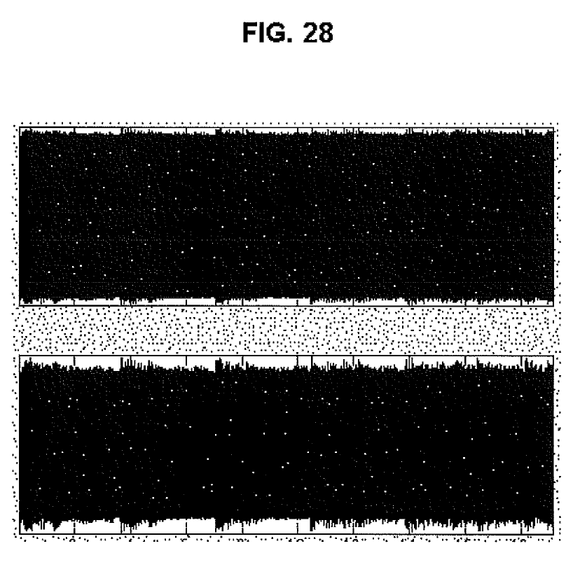

FIG. 28 is an explanatory diagram illustrating the nature of the respective waveforms of a first set of multimedia information for distribution and a second set of multimedia information for distribution. As shown in the diagram, since both the first set of multimedia information for distribution and the second set of multimedia information for distribution are signals obtained as a result of mixing with noise, both waveforms are clearly inferior in quality to the original signal.

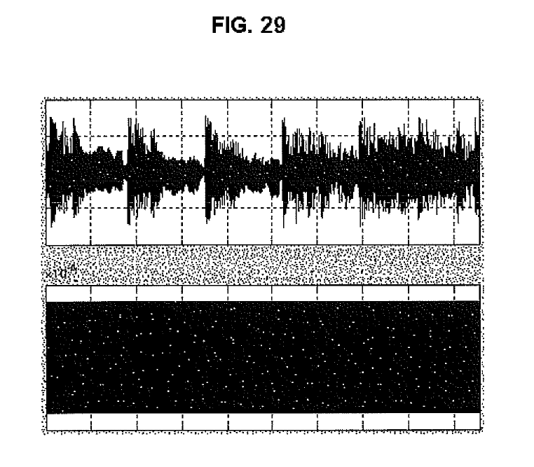

FIG. 29 is an explanatory diagram illustrating the waveforms of the two component signals obtained as a result of taking the above as input and applying independent component analysis like that described above thereto.

Among the two waveforms shown in the diagram, it can be seen that one waveform is at first glance an almost exact copy of the original multimedia signal, while the shape of the other waveform is like a solid belt, which indicates noise.

Another case like the above example will now be considered, being different only in that 0.4 has been selected as the initial value.

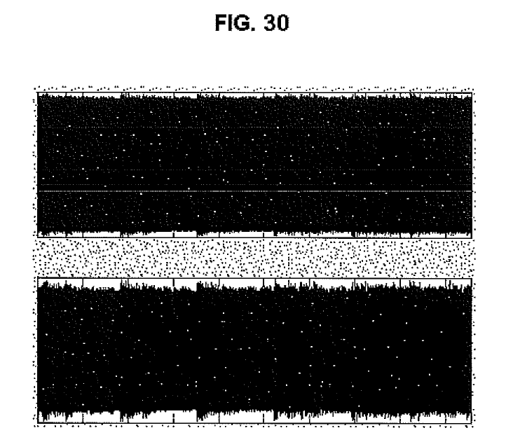

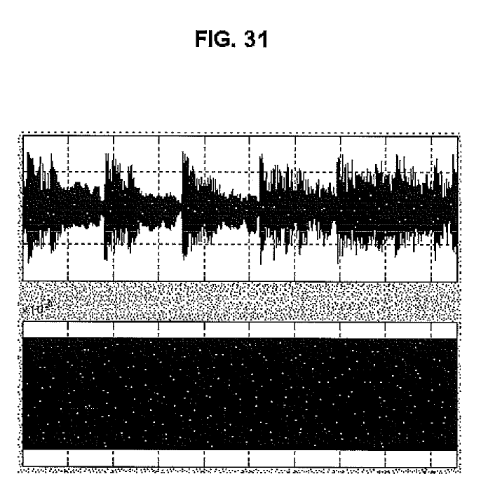

FIG. 30 is an explanatory diagram illustrating the respective waveforms of a first set of multimedia information for distribution and a second set of multimedia information for distribution. Similar to FIG. 28, it can be seen from the results shown in the diagram that quality has been reduced in comparison with the original signal.

FIG. 31 is an explanatory diagram illustrating the waveforms of the two component signals obtained as a result of taking the above as input and applying independent component analysis like that described above thereto. Similar to FIG. 29, one signal is a high-quality waveform almost exactly like the waveform of the original multimedia information, while the other signal has a noise-like waveform.

In this way, two low-quality sets of multimedia information for distribution are separated into a high-quality set of multimedia information and a mixed noise signal by using independent component analysis.

Next, the case will be considered wherein a waveform with an initial value of 0.2 and a mixing ratio of 9:1, and a waveform with an initial value of 0.4 and a mixing ratio of 8:2, are selected. In other words, this corresponds to the case wherein the information has been provided to the wrong party, or the case wherein owing to some circumstances a set of multimedia information for distribution has been eavesdropped or snooped.

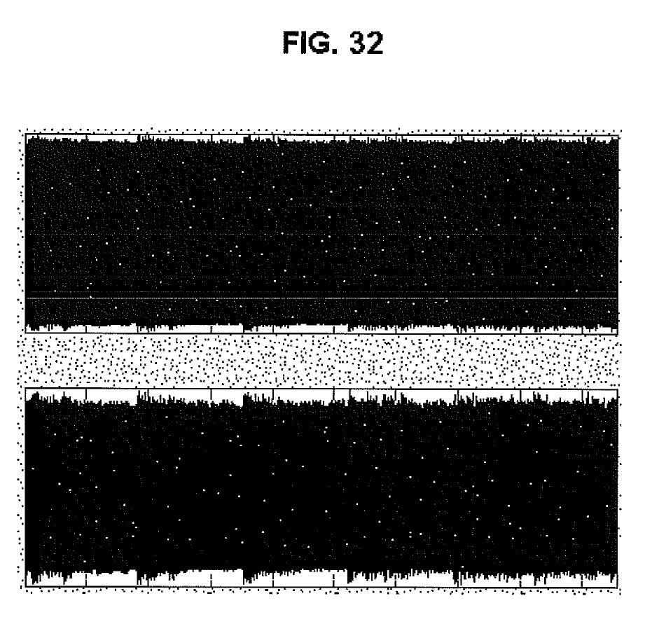

FIG. 32 is an explanatory diagram illustrating the respective waveforms of a first set of multimedia information for distribution and a second set of multimedia information for distribution. This diagram is equivalent to taking the upper waveform of FIG. 28 and the lower waveform of FIG. 30 and arranging them in that order.

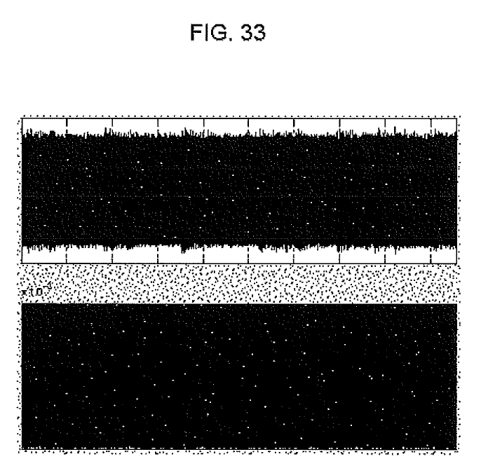

FIG. 33 is an explanatory diagram illustrating the waveforms of the two component signals obtained as a result of taking the above as input and applying independent component analysis like that described above thereto.

Unlike FIGS. 28 and 30, the original multimedia information is not restored at all, and in both cases only noise-filled waveforms are obtained. (Incidentally, among the waveforms in the diagram, the upper waveform corresponds to an audio waveform containing an amount of noise equivalent to the two sets of multimedia information for distribution, and the lower waveform corresponds to simple noise.)

In other words, a high-quality set of multimedia information cannot be obtained unless the two sets of multimedia information for distribution share in common both a dynamical system that determines the chaotic sequence (in the present embodiment, the chaotic sequence is determined by a function F(x) wherein recurrence equations are used), and an initial value to be used.

In this way, once the two component signals are obtained, the information selector 613 selects, from among the two output component signals, the component signal that exhibits the lower degree of chaotic sequence characteristics, and selects this component signal as the high-quality multimedia information (step S664).

Since the goal is to obtain a high-quality set of multimedia information, it is difficult to determine whether or not a signal is the desired set of multimedia information. However, as described above, it is possible to determine whether a signal exhibits characteristics of a chaotic sequence, i.e., whether or not the signal resembles a chaotic sequence, by using a variety of techniques.

Thus, the signal that does not resemble a chaotic sequence is selected as the high-quality multimedia information. Consequently, the CPU, working in conjunction with components such as the RAM and hard disk, or similar memory, functions as the information selector 613.

Furthermore, the high-quality reproducer 614 saves the selected high-quality set of multimedia information to the hard disk, and reproduces this information in accordance with the user's wishes (step S665). The process then returns to step S651.

Consequently, the CPU, working in conjunction with components such as the RAM, hard disk, and monitor, and similar components, functions as the high-quality reproducer 614.

In addition, in the case where there is another type of command input from the user (step S652; Other), corresponding processing is executed (step S671), and then the process returns to step S651.

It should be appreciated that this process may also conduct control using appropriate parallel processing, concurrent processing, or coroutine-type processing. As necessary, the processing order may also be changed while keeping with the spirit of the invention.

In this way, in the present embodiment the first set of multimedia information for distribution and the second set of multimedia information for distribution function as a type of “cryptogram”, while the initial value functions as a type of “encryption key”. However, the initial value that serves as the “encryption key” is managed on the side of the server device 311, and thus is not disclosed to the terminal equipment 331 on the user's side.

In addition, the first set of multimedia information for distribution and the second set of multimedia information for distribution, which serve as the “cryptogram”, can be used in and of themselves for preview purposes, and thus no problem is posed even if a third party eavesdrops on or snoops such information. In some cases, this may serve as advertising.

Moreover, the high-quality set of multimedia information is only obtained at the terminal equipment 331 on the user's side after first obtaining the combination of a correct first set of multimedia information for distribution and second set of multimedia information for distribution. These two sets of information also function as a type of “security key pair”.

Consequently, as a result of the present embodiment, when a user who has previewed a low-quality set of multimedia information requests a high-quality version of the multimedia information, the high-quality version of the multimedia information is obtained by providing another previewable, low-quality set of the multimedia information, thereby eliminating the need for the user to manage encryption keys or other information.

As a result of the present invention, a multimedia information providing system, server device, terminal equipment, multimedia information providing method is provided, as well as a computer-reading medium recording a program that realizes the same on a computer or digital signal processor, wherein when a user who has previewed a low-quality set of multimedia information requests a high-quality version of the multimedia information, the high-quality version of the multimedia information is obtained by providing another previewable, low-quality set of the multimedia information, thereby eliminating the need for the user to manage encryption keys or other information.

Various embodiments and changes may be made thereunto without departing from the broad spirit and scope of the invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

This application is based on Japanese Patent Application No. 2007-77573 filed on Mar. 23, 2007 and including specification, claims, drawings and summary. The disclosure of the above Japanese Patent Application is incorporated herein by reference in its entirety.

What is claimed is:

1. A multimedia information providing system comprising a server device; and a terminal equipment, wherein:
(a) the server device comprises;
a multimedia information storage component, having multimedia information including at least one of audio or video data stored in advance thereon;
a chaotic sequence generator that generates a random number sequence derived from a chaotic sequence, taking a value provided as input as the initial value thereof;
an initial value selector that selects an initial value;
a first random number sequence acquirer that provides the selected initial value as input into the chaotic sequence generator, and acquires the random number sequence generated thereby;
a first mixer that mixes the random number acquired by the first random number sequence acquirer into the stored multimedia information as a noise signal at a first mixing ratio, thereby obtaining a first set of multimedia information for distribution;
a first transmitter that transmits the obtained first set of multimedia information for distribution to the terminal equipment; and
an initial value storage component that stores the selected initial value in association with the terminal equipment;
(b) the terminal equipment comprises;
a first receiver that receives the first set of multimedia information for distribution transmitted from the server device;
a first reproducer that reproduces the received first set of multimedia information for distribution; and
a request transmitter that transmits to the server device a quality improvement request that requests a second set of multimedia information, being a higher-quality version of the first set of multimedia information for distribution that was reproduced;
(c) the server device further comprises;
a request receiver that receives the quality improvement request transmitted from the terminal equipment;
a second random number sequence acquirer that takes the initial value that was stored in the initial value storage component in association with the terminal equipment that transmitted the received quality improvement request, provides this initial value as input into the chaotic sequence generator, and then acquires the random number sequence generated thereby;
a second mixer that mixes the random number acquired by the second random number sequence acquirer into the stored multimedia information as a noise signal at a second mixing ratio that is different from the first mixing ratio, thereby obtaining a second set of multimedia information for distribution; and
a second transmitter that transmits the obtained second set of multimedia information for distribution to the terminal equipment; and
(d) the terminal equipment further comprises;
a second receiver that receives the second set of multimedia information for distribution transmitted from the server device;
a component analyzer that takes the received first set of multimedia information for distribution and the received second set of multimedia information for distribution as input signals and performs component analysis, thereby obtaining two component signals;
a information selector that selects, from among the two output component signals, the component signal that exhibits the lower degree of chaotic sequence characteristics, and selects this component signal as the high-quality version of the multimedia information; and
a high-quality reproducer that reproduces the selected high-quality version of the multimedia information.

2. The multimedia information providing system according to claim 1, wherein:
the degree to which a given component signal exhibits the characteristics of a chaotic sequence is determined by a return map, the correlation dimension, or the maximal Lyapunov exponent of the component signal.

3. The multimedia information providing system according to claim 1, wherein:
the chaotic sequence is obtained by iteratively applying a function, F(x) having a domain and range of values given by a predefined region D, to an arbitrary initial value z included in D, thus yielding a sequence of the form
z, F(z), F(F(z)), F(F(F(z))), . . .
and wherein for a given component signal
s₁, s₂, s₃, . . .
a characteristic value expressing the degree to which the component signal exhibits characteristics of the chaotic sequence is determined by taking the total sum, the sum of squares, the average, or the weighted average of the error

|sᵢ₊₁−F(sᵢ)|

of the i+1 (i≧1) element in the component signal, whereby the degree to which the component signal exhibits the characteristics of a chaotic sequence is high to the extent that this characteristic value is small.

4. The multimedia information providing system according to claim 3, wherein:
the function F(x) is a Chebyshev polynomial Tₐ of order a (a≧2), defined as
Tₐ(cos θ)=cos(aθ)

5. The multimedia information providing system according to claim 1, wherein:
the terminal equipment further comprises a second reproducer that reproduces the received second set of multimedia information for distribution.

6. The multimedia information providing system according to claim 1, wherein:
in the server device, the initial value selector randomly selects an initial value for each terminal equipment.

7. A server device of the multimedia information providing system of claim 1.

8. A terminal equipment of the multimedia information providing system of any of claims 1 to 6.

9. A multimedia information providing method making use of a server device and a terminal equipment, the server device comprising a multimedia information storage component wherein multimedia information, including at least one of audio or image data, is stored in advance thereon, a chaotic sequence generator, an initial value selector, a first random number sequence acquirer, a first mixer, a first transmitter, an initial value storage component, a request receiver, a second random number sequence acquirer, a second mixer, and a second transmitter, and the terminal equipment comprising a first receiver, a first reproducer, a request transmitter, a second receiver, a component analyzer, a information selector, and a high-quality reproducer, the method comprising the steps of:
(a) on the server device,
generating a chaotic sequence, wherein the chaotic sequence generator generates a random number sequence derived from a chaotic sequence, taking a value provided as input as an initial value;
selecting an initial value, wherein the initial value selector selects an initial value;
acquiring a first random number sequence, wherein the first random number sequence acquirer provides the selected initial value as input into the chaotic sequence generation step and acquires the random number sequence generated thereby;
mixing a first time, wherein the first mixer mixes the random number acquired in the first random number sequence acquisition step into the stored multimedia information as a noise signal at a first mixing ratio, thereby obtaining a first set of multimedia information for distribution;
transmitting a first time, wherein the first transmitter transmits the obtained first set of multimedia information for distribution to the terminal equipment; and
storing an initial value, wherein the initial value storage component stores a selected initial value in association with the terminal equipment;
(b) on the terminal equipment,
receiving a first time, wherein the first receiver receives the first set of multimedia information for distribution that was transmitted from the server device;
reproducing a first time, wherein the first reproducer reproduces the received first set of multimedia information for distribution;
transmitting a request, wherein the request transmitter transmits to the server device a quality improvement request that requests a second set of multimedia information, being a higher-quality version of the first set of multimedia information for distribution that was reproduces;
(c) on the server device,
receiving a request, wherein the request receiver receives the quality improvement request transmitted from the terminal equipment;
acquiring a second random number sequence, wherein the second random number sequence acquirer takes the initial value that was stored in the initial value storage step in association with the terminal equipment that transmitted the received quality improvement request, provides this initial value as input into the chaotic sequence generation step, and then acquires the random number sequence generated thereby;
mixing a second time, wherein the second mixer mixes the random number acquired in the second random number sequence acquisition step into the stored multimedia information as a noise signal at a second mixing ratio that is different from the first mixing ratio, thereby obtaining a second set of multimedia information for distribution; and
transmitting a second time, wherein the second transmitter transmits the obtained second set of multimedia information for distribution to the terminal equipment; and
(d) on the terminal equipment,
receiving a second time, wherein the second receiver receives the second set of multimedia information for distribution transmitted from the server device;
conducting component analysis, wherein the component analyzer takes the received first set of multimedia information for distribution and the received second set of multimedia information for distribution as input signals and performs component analysis, thereby obtaining two component signals;
selecting information, wherein the information selector selects, from among the two output component signals, the component signal that exhibits the lower degree of chaotic sequence characteristics, and selects this component signal as the high-quality version of the multimedia information; and
reproducing at high-quality, wherein the high-quality reproducer reproduces the selected high-quality version of the multimedia information.

10. The multimedia information providing method according to claim 9, wherein:
the degree to which a given component signal exhibits the characteristics of a chaotic sequence is determined by a return map, the correlation dimension, or the maximal Lyapunov exponent of the component signal.

11. The multimedia information providing method according to claim 9, wherein:
the chaotic sequence is obtained by iteratively applying a function F(x), having a domain and range of values given by a predefined region D, to an arbitrary initial value z included in D, thus yielding a sequence of the form
z, F(z), F(F(z)), F(F(F(z))), . . .
and wherein for a given component signal
s₁, s₂, s₃, . . .
a characteristic value expressing the degree to which the component signal exhibits characteristics of the chaotic sequence is determined by taking the total sum, the sum of squares, the average, or the weighted average of the error

|sᵢ₊₁−F(sᵢ)|

of the i+1(i≧1) element in the component signal, whereby the degree to which the component signal exhibits the characteristics of a chaotic sequence is high to the extent that this characteristic value is small.

12. The multimedia information providing method according to claim 11, wherein:
the function F(x) is a Chebyshev polynomial Ta(x) of order a (a≧2), defined as
Tₐ(cos θ)=cos(aθ)

13. The multimedia information providing method according to claim 9, wherein:
the terminal equipment further comprises a second reproducer, and the method further comprises the step of reproducing a second time, wherein the second reproducer reproduces the received second set of multimedia information for distribution.

14. The multimedia information providing method according to claim 9, wherein:
in the server device, during the initial value selection step, an initial value is randomly selected for each terminal equipment.

15. A computer-readable medium recording a program that causes a first computer and a second computer to function as the multimedia information providing system according to claim 1, wherein:
the program causes the first computer to function as the respective components of the server device; and
the program causes the second computer to function as the respective components of the terminal equipment.

16. A computer-readable medium recording a program that causes a computer to function as the respective components of the server device according to claim 7.

17. A computer-readable medium recording a program that causes a computer to functions as the respective components of the terminal equipment according to claim 8.
